(19) United States
(12) Patent Application Publication
(10) Pub. No.: US 2025/0349474 A1
(43) Pub. Date: Nov. 13, 2025

(54) INITIALLY ANODE-FREE ZINC-CARBON SUPERCAPACITORS

(71) Applicant: The Regents of the University of California, Oakland, CA (US)

(72) Inventors: Tse Nga Ng, San Diego, CA (US); Lulu Yao, San Diego, CA (US)

(21) Appl. No.: 19/199,158

(22) Filed: May 5, 2025

Related U.S. Application Data
(60) Provisional application No. 63/645,318, filed on May 10, 2024.

(51) Int. Cl. H01G 11/32; H01G 11/56; H01G 11/66; H01G 11/86

(52) U.S. Cl. CPC H01G 11/32; H01G 11/56; H01G 11/66; H01G 11/86

(57) ABSTRACT

A method of fabricating an electrochemical cell can include assembling a first electrochemical cell comprising a cathode comprising a layer of activated carbon, a first anode, and a first electrolyte comprising chloride ions, applying a first voltage across the cathode and the first anode to decompose the first electrolyte, depositing a layer of zinc over the layer of activated carbon, assembling a second electrochemical cell comprising the cathode, an anode current collector for a second anode, and a second electrolyte, and applying a reduction voltage across the cathode and the anode current collector for the second anode to strip the layer of zinc from the cathode and deposit the layer of zinc on a surface of the anode current collector to form the second anode.

### CROSS-REFERENCE TO RELATED APPLICATIONS

This application claims priority to U.S. Provisional Application No. 63/645,318, entitled “Anode-Free, Wide Temperature Supercapacitors,” filed May 10, 2024, the entirety of which is hereby incorporated herein by reference.

### FIELD

The present disclosure relates generally to rechargeable electrochemical cells.

### BACKGROUND

Rechargeable electrochemical cells (e.g., supercapacitors) with zinc metal anodes are of interest due to their low cost, safety, and high divalent capacity. However, existing rechargeable electrochemical cells with zinc metal anodes typically use excess amounts of zinc foil to compensate for the depletion of active zinc upon redox cycling. This zinc surplus frequently leads to a significant imbalance in the capacity ratio of negative to positive electrodes (n/p), thereby diminishing the overall specific energy in a full cell.

### SUMMARY

In general, electrochemical cells and methods of fabricating electrochemical cells are provided.

In one aspect, an electrochemical cell is provided including an anode and a cathode. Prior to application of a reduction voltage to the anode, the cathode can include activated carbon and a zinc deposit, and the anode can include no zinc deposit. Following application of the reduction voltage to the anode, the anode can include the zinc deposit, and the cathode can include no zinc deposit. In some embodiments, following the application of the voltage to the anode, a thickness of the zinc deposit on the anode is less than 10 μm, and a capacity ratio (n/p) of the electrochemical cell is less than 5.

In some implementations, the anode can include a current collector that includes a nanoparticle-modified surface. The nanoparticle-modified surface can include copper nanoparticles or another suitable type of nanoparticle. The nanoparticle-modified surface can be fabricated using a radio frequency sputtering process or another suitable fabrication process. Following the application of the voltage to the anode, the zinc deposit can be layered over the nanoparticle-modified surface.

In another aspect, an electrochemical cell is provided including an anode and a cathode. The cathode can include a substrate and a layer of activated carbon disposed on a surface of the substrate. The substrate can include carbon cloth. The layer of active carbon can include pores. In some implementations, the pores are formed by decomposing an electrolyte with chloride anions using the cathode. The electrolyte can include zinc chloride. A capacitance of the cathode can be at least 200 F g⁻¹.

In another aspect, a method of fabricating an electrochemical cell is provided. The method can include assembling a first electrochemical cell including a cathode including a layer of activated carbon, a first anode, and a first electrolyte including chloride ions, applying a first voltage across the cathode and the first anode to decompose the first electrolyte, depositing a layer of zinc over the layer of activated carbon, assembling a second electrochemical cell including the cathode, an anode current collector for a second anode, and a second electrolyte, and applying a reduction voltage across the cathode and the anode current collector for the second anode to strip the layer of zinc from the cathode and deposit the layer of zinc on a surface of the anode current collector to form the second anode.

In some implementations, the first electrolyte can include zinc chloride. The first voltage applied to the cathode and the first anode to decompose the first electrolyte can be greater than 2.1 V. A thickness of the layer of zinc can be less than less than 5 μm.

In some embodiments, following decomposition of the first electrolyte, the layer of activated carbon includes a plurality of pores. In some embodiments, prior to assembling the second electrochemical cell, a surface of the anode current collector can be modified with nanoparticles to form a nanoparticle-modified surface. Modifying the surface of the anode current collector can include depositing the nanoparticles by radio frequency sputtering. The nanoparticles can include copper nanoparticles.

The details of one or more variations of the subject matter described herein are set forth in the accompanying drawings and the detailed description. Other features and advantages of the subject matter described herein will be apparent from the description, the drawings, and the claims.

### BRIEF DESCRIPTION OF THE FIGURES

The patent or application file contains at least one drawing executed in color. Copies of this patent or patent application publication with color drawing(s) will be provided by the Office upon request and payment of the necessary fee.

The described subject matter will be more readily understood from the following detailed description in conjunction with the accompanying drawings, in which:

FIG. 1A shows a block diagram of an exemplary porous activated carbon (AC) electrochemical cell;

FIG. 1B shows a block diagram of an initially anode-free electrochemical cell;

FIG. 1C shows a block diagram of an exemplary initially anode-free, porous AC electrochemical cell;

FIG. 2 shows a photograph of an example anode;

FIG. 3 shows a photograph of another example initially anode-free supercapacitor;

FIG. 4A shows a photograph of an anode of another example initially anode-free supercapacitor;

FIG. 4B shows a photograph of a cathode of the supercapacitor of FIG. 4A;

FIG. 4C shows a cross-sectional diagram of the supercapacitor of FIGS. 4A-4B;

FIG. 5 shows a flow diagram of an exemplary method of fabricating an initially anode-free, porous AC electrochemical cell;

FIG. 6A shows (i) a diagram of an electrochemical cell prior to activation of an AC cathode and (ii) a cyclic voltammetry curve of an example AC/Zinc foil supercapacitor;

FIG. 6B shows (i) a diagram of the electrochemical cell of FIG. 6A(i) following activation of the AC cathode and (ii) a plot of cell potential over time during activation of an AC cathode inside zinc chloride electrolyte;

FIG. 6C shows (i) a diagram of the electrochemical cell of FIG. 6B(i) following deposition of a zinc foil to the cathode and (ii) a plot of potential over time during deposition of zinc from a zinc foil to an AC cathode;

FIG. 6D shows (i) a diagram of the AC cathode of the electrochemical cell of FIG. 6C(i) paired with a copper current collector and (ii) a plot of cell potential over time during stripping of a zinc foil from an AC cathode and deposition of the zinc foil on a copper current collector;

FIG. 6E shows (i) a diagram of a completed initially anode-free, porous AC electrochemical cell and (ii) a cyclic voltammetry curve of an example completed initially anode-free, porous AC electrochemical cell;

FIG. 7A shows a diagram of AC (i) before and (ii) after activation by chlorine gas;

FIG. 7B shows a scanning electron microscopy (SEM) image of an example AC cathode prior to activation;

FIG. 7C shows an SEM image of the AC cathode of FIG. 7B following activation;

FIG. 7D shows a cyclic voltammetry curve of the AC cathode of FIG. 7B during activation;

FIG. 7E shows a cyclic voltammetry curves of the un-activated AC cathode of FIG. 7B and the activated AC cathode of FIG. 7C;

FIG. 7F shows a plot of gravimetric capacity for the activated AC cathode of FIG. 7C;

FIG. 8A shows a cyclic voltammetry curve of an example AC cathode;

FIG. 8B shows a capacity-voltage profile of the AC cathode of FIG. 8A;

FIG. 8C shows a plot of capacity change over time for the AC cathode of FIG. 8A;

FIG. 9A shows Bunauer-Emmett-Teller (BET) surface analysis of a carbon cloth substrate before and after activation of the carbon cloth by chlorine gas;

FIG. 9B shows BET surface analysis of AC on a carbon cloth substrate before and after activation of the AC by chlorine gas;

FIG. 9C shows histograms of pore radius distribution in AC before and after activation of the AC by chlorine gas;

FIG. 10A shows voltage profiles of an example AC cathode at various charge/discharge currents.

FIG. 10B shows a charging/discharging stability test of an example AC cathode.

FIG. 10C shows capacity-voltage profiles of plain carbon cloth and chlorine-activated carbon cloth;

FIG. 10D shows a plot of capacity versus activation time for plain carbon cloth and carbon cloth with AC;

FIG. 10E shows a plot of imaginary impedance versus real impedance of AC before and after chlorine activation;

FIG. 11A shows a magnified view of a zinc anode with an unmodified current collector;

FIG. 11B shows a magnified view of a zinc anode with a current collector that has been modified with nanoparticles;

FIG. 12A shows an SEM image of an unmodified copper foil;

FIG. 12B shows an SEM image of an example nanoparticle-modified copper foil;

FIG. 13 shows an SEM image of a cross-section of an example zinc anode with a nanoparticle-modified copper current collector;

FIG. 14A shows SEM images of a zinc layer on an example nanoparticle-modified copper current collector;

FIG. 14B shows SEM images of a zinc layer on another example nanoparticle-modified copper current collector;

FIG. 14C shows SEM images of a zinc layer on yet another example nanoparticle-modified copper current collector;

FIG. 15A shows an x-ray diffraction pattern of zinc plating on plain copper foil;

FIG. 15B shows an x-ray diffraction pattern of zinc plating on an example nanoparticle-modified copper foil;

FIG. 15C shows an x-ray diffraction pattern of zinc plating on another example nanoparticle-modified copper foil;

FIG. 15D shows a plot of the peak intensity ratio of Z(002) to Z(100) as a function of deposition current density for various copper nanoparticle modification power levels;

FIG. 15E shows a plot of voltage during zinc plating on bare copper and on copper nanoparticle-modified current collector;

FIG. 15F shows a plot of voltage at the thousandth redox cycle on a nanoparticle-modified current collector.

FIG. 15G shows a plot of a peak intensity ratio of Zn(002) to Zn(100) versus state of charge;

FIG. 15H shows a plot of coulombic efficiency as a function of redox cycles and plating/stripping current densities, on example bare copper and copper nanoparticle-modified current collectors;

FIG. 16A shows x-ray diffraction peaks of reference copper and zinc foils;

FIG. 16B shows an x-ray diffraction pattern of zinc electrodeposition at different various current densities on a graphite surface modified copper nanoparticles;

FIG. 16C shows a plot of a ratio of x-ray peaks versus electrodeposition current density shown in FIG. 16B;

FIG. 17A shows voltage profiles of zinc deposition on a bare copper foil;

FIG. 17B shows voltage profiles of zinc deposition on an example copper nanoparticle-modified copper foil;

FIG. 17C shows voltage profiles of another example copper nanoparticle-modified copper foil;

FIG. 18A shows example x-ray diffraction results of zinc deposition at various state-of-charge increasing from 25% to 100%;

FIG. 18B shows example x-ray diffraction results of zinc stripping from 100% to 25%;

FIG. 19A shows a voltage profile of a charging and a discharging process of an example zinc anode at different current densities;

FIG. 19B shows corresponding areal capacity changes with current density for the example anode of FIG. 19A;

FIG. 20 shows a plot of electrode capacity ratio versus specific capacity;

FIG. 21A shows areal capacity data for two example electrochemical cells across 50,000 charge-discharge cycles;

FIG. 21B shows Coulombic efficiency data across 50,000 charge-discharge cycles for the two example electrochemical cells of FIG. 21A;

FIG. 21C shows a plot of energy versus power density for the two example electrochemical cells of FIG. 21A, over a range of temperatures;

FIG. 22A shows a plot of cycling performance data for an example electrochemical cell with an unmodified anode;

FIG. 22B shows a plot of cell potential versus time at the anode side for the example cell of FIG. 22A;

FIG. 22C shows a plot of the charging/discharging cycle of the anode of the example cell of FIG. 22A at cycle 10 and cycle 10,000;

FIG. 23A shows a cyclic voltammetry curve of an example electrochemical cell with 2 M ZnSO₄ in deionized water as its electrolyte;

FIG. 23B shows cycling performance data for the example cell of FIG. 23A;

FIG. 23C shows an SEM image showing the surface morphology of the anode of the example cell of FIG. 23A after 1000 full charging/discharging cycles;

FIG. 23D shows a cyclic voltammetry curve of an example electrochemical cell with 2 M Zinc bis(trifluoromethylsulfonyl)imide in propylene carbonate as its electrolyte;

FIG. 23E shows cycling performance data for the example cell of FIG. 23D;

FIG. 23F shows an SEM image showing the surface morphology of the anode of the example cell of FIG. 23D after 1000 full charging/discharging cycles;

FIG. 23G shows the self-discharge voltage drop of an example electrochemical cell with 15 M ZnCl₂ as its electrolyte;

FIG. 23H shows a plot of the potential change of zinc on the nanoparticle-modified anode of the example cell of FIG. 23G during the self-discharge process;

FIG. 23I shows a plot of the self-discharge performance of the electrochemical cell of FIG. 23A;

FIG. 23J shows a plot of the potential change of zinc on the nanoparticle-modified anode of the example cell of FIG. 23A during the self-discharge process;

FIG. 24A shows a plot of current versus potential for a water in salt (WIS) electrolyte at various concentrations at a first temperature;

FIG. 24B shows a plot of current versus potential for a water in salt (WIS) electrolyte at various concentrations at a second temperature;

FIG. 24C shows a plot of conductivity versus temperature for a water in salt (WIS) electrolyte at various concentrations;

FIG. 25A shows impedance data for an example supercapacitor;

FIG. 25B shows cyclic voltammetry curves for the example supercapacitor of FIG. 25A;

FIG. 25C shows voltage-capacity profiles for the example supercapacitor of FIG. 25A;

FIG. 26A shows a cyclic voltammetry curve for the example device shown in FIG. 3;

FIG. 26B shows galvanostatic charge-discharge characteristics for the example device shown in FIG. 3;

FIG. 26C shows cycling stability data for the example device of FIG. 3;

FIG. 27A shows cumulative capacity data for an example supercapacitor fabricated according to the provided techniques compared to example existing zinc ion batteries and example existing zinc ion capacitors; and

FIG. 27B shows specific energy and specific power data for an example supercapacitor fabricated according to the provided techniques compared to example existing zinc ion batteries and example existing zinc ion capacitors.

### DETAILED DESCRIPTION

Disclosed herein are techniques for fabricating an electrochemical cell with a balanced electrode capacity. An electrochemical cell produced using the described techniques can include a porous activated carbon (AC) cathode and a zinc-plated anode with a nanoparticle-modified current collector. The porous AC cathode can be formed using a specialized electrolyte reaction configured to increase the porosity and gravimetric capacity of the cathode material. Following fabrication of the porous AC cathode, a layer of zinc can be deposited on the cathode, and an un-plated nanoparticle-modified current collector can be coupled to the porous AC cathode to form an “anode-free” electrochemical cell. The layer of zinc can then be stripped from the cathode and deposited on the nanoparticle-modified current collector to form the zinc-plated anode. The nanoparticle modifications in the current collector can enable the zinc to be deposited in a thin layer (e.g., a layer that is less than or equal to approximately 1 μm thick) while mitigating dendritic loss.

The porous AC cathode, together with the zinc-plated, nanoparticle-modified anode, can provide the disclosed electrochemical cells with improved Coulombic efficiency and cycle life compared to existing electrochemical cells with zinc metal anodes. Some electrochemical cells fabricated using the disclosed techniques can deliver a specific energy of at least 192 W h kg⁻¹ at a specific power of 1.4 kW kg⁻¹ and can maintain a capacity of at least 84% after 50,000 full charge-discharge cycles up to 2 V. In some embodiments, the disclosed techniques can produce an electrochemical cell having a cumulative capacity that surpasses that of zinc ion batteries (e.g., a cumulative capacity of 19.8 A h cm 2). These properties can enable the electrochemical cells described herein to be implemented in high-endurance applications, including un-interruptible power supplies and energy-harvesting systems that demand frequent cycling.

Certain embodiments will now be described to provide an overall understanding of the principles of the structure, function, manufacture, and use of the devices, systems, and methods disclosed herein. One or more examples of these embodiments are illustrated in the accompanying drawings. Those skilled in the art will understand that the devices, systems, and methods specifically described herein and illustrated in the accompanying drawings are non-limiting embodiments and that the scope of the present invention is defined solely by the claims. The features illustrated or described in connection with one exemplary embodiment may be combined with the features of other embodiments. Such modifications and variations are intended to be included within the scope of the present invention.

Further, in the present disclosure, like-named components of the embodiments generally have similar features, and thus within a particular embodiment each feature of each like-named component is not necessarily fully elaborated upon. Additionally, to the extent that linear or circular dimensions are used in the description of the disclosed systems, devices, and methods, such dimensions are not intended to limit the types of shapes that can be used in conjunction with such systems, devices, and methods. A person skilled in the art will recognize that an equivalent to such linear and circular dimensions can easily be determined for any geometric shape.

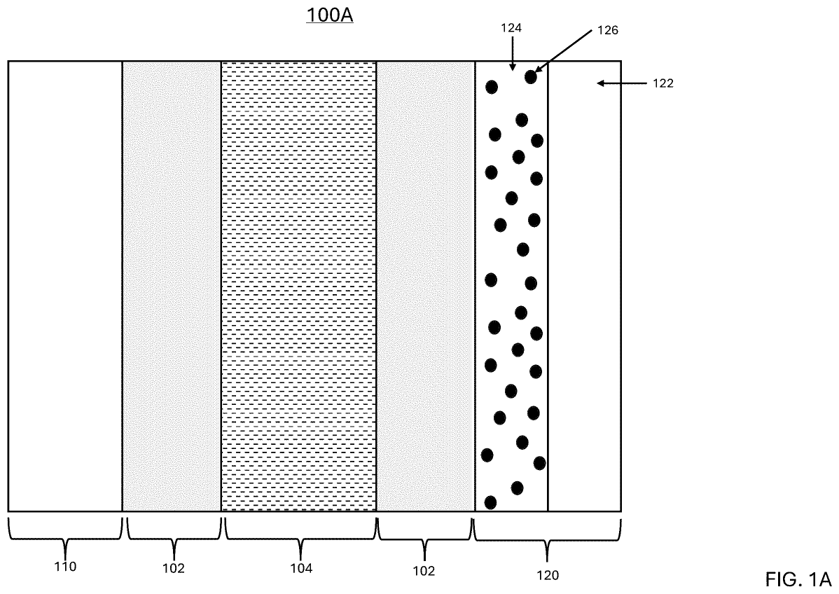

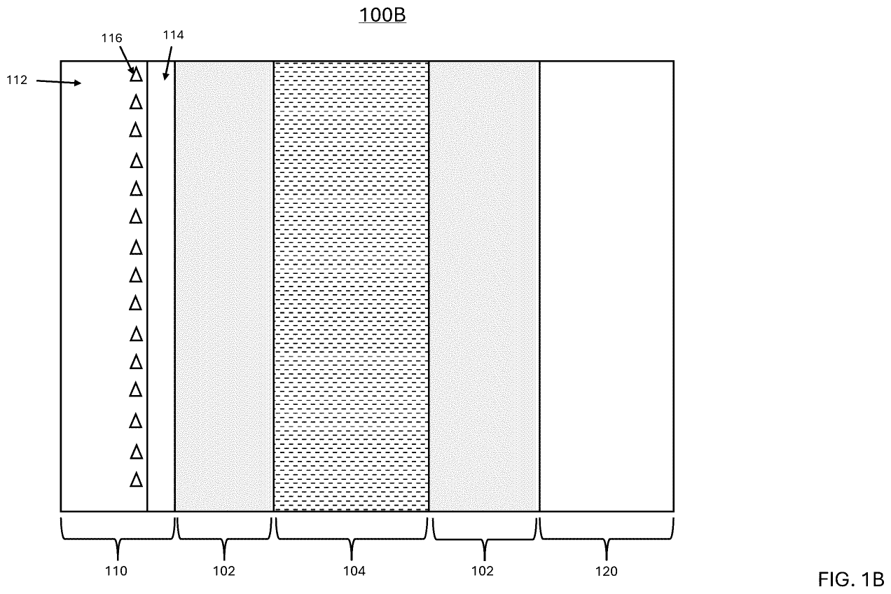

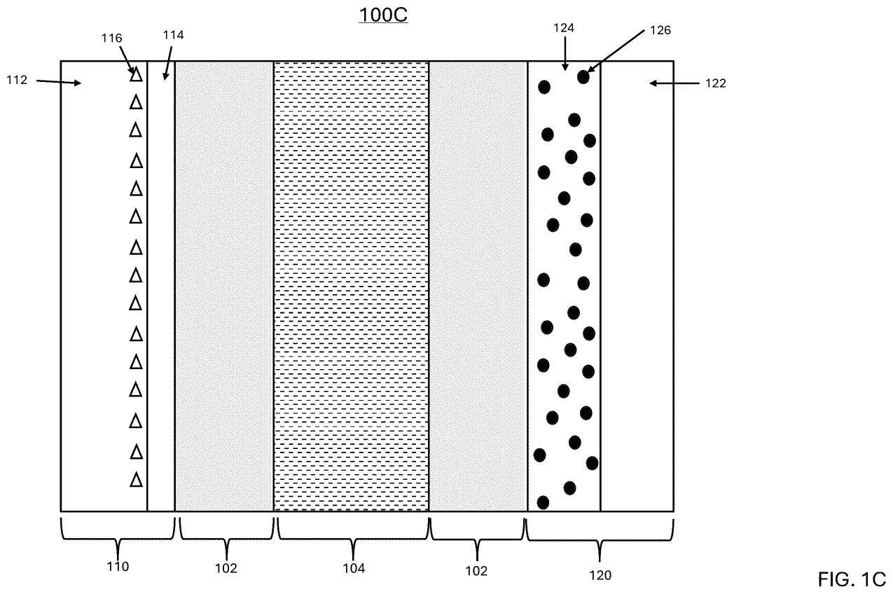

FIGS. 1A-1C show block diagrams of three exemplary electrochemical cells 100A, 100B, and 100C. All three electrochemical cells 100A, 100B, 100C include an anode 110 and a cathode 120 separated by an electrolyte 102 and a separator 104. The cathode 120 of the electrochemical cell 100A and the electrochemical cell 100C includes a porous AC layer 124 (FIG. 1A, FIG. 1C). The anode 110 of the electrochemical cell 100B and the electrochemical cell 100C includes a nanoparticle-modified current collector 112 that is plated with a layer of zinc 114.

The electrolyte 102 can be any suitable electrolyte. In some implementations, the electrolyte 102 is zinc chloride (ZnCl₂) with a concentration between approximately 7M and approximately 15M, for example 7M ZnCl₂, 8M ZnCl₂, 9M ZnCl₂, 10M ZnCl₂, 11M ZnCl₂, 12M ZnCl₂, 13M ZnCl₂, 14M ZnCl₂, or 15M ZnCl₂. In some implementations, the electrolyte 102 is a low-temperature tolerant electrolyte configured to operate at temperatures as low as −60° C.

The separator 104 can include any suitable separator material. Example separator materials include (but are not limited to) glass microfiber and cellulose paper.

The porous AC layer 124 of the cathode 120 in the electrochemical cells 100A, 100C (FIG. 1A, FIG. 1C) can be disposed on a substrate 122. The substrate 122 can include a material that is electrochemically stable when exposed to electric potentials exceeding 1 V. For example, the substrate 122 can include carbon cloth.

As shown in FIGS. 1A and 1C, the porous AC layer 124 can include pores 126. As explained in further detail below, the cathode 120 with the porous AC layer 124 can be formed by depositing a layer of AC onto the substrate 122 to form an un-activated cathode, assembling an electrochemical cell (distinct from the completed cells such as cells 100A-100C) that includes the un-activated cathode, an anode, and an electrolyte having chloride anions, and applying a voltage across the un-activated cathode and the anode to initiate decomposition of the electrolyte into chlorine gas. The chlorine gas can increase the porosity of the AC layer and produce the pores 126, which can have radii ranging from approximately 1 nm and up to approximately 1000 micrometers.

The pores 126 can increase the capacitance of the porous AC cathode 120 of cells 100A, 100C relative to the un-activated cathode. The capacitance of the un-activated cathode may be between 100 Farad per gram (F g⁻¹) and 200 F g⁻¹, while the capacitance of the porous AC cathode 120 of cells 100A, 100C can exceed 200 F g⁻¹. In some implementations, the capacitance of the porous AC cathode 120 of cells 100A, 100C can be greater than 400 F g⁻¹.

The nanoparticle-modified current collector 112 of the anode 110 of cells 100B, 100C (FIGS. 1B, 1C) can be formed from any suitable current collector material. In some implementations, the current collector 112 is a copper current collector (e.g., copper foil). In some implementations, the current collector 112 is a stainless-steel current collector (e.g., stainless-steel foil). A surface of the current collector 112 can be modified with nanoparticles 116. The nanoparticles 116 can be any suitable type of nanoparticles, for example copper nanoparticles.

The nanoparticle modification can be performed using any suitable technique. For instance, in some implementations, the nanoparticle-modified current collector 112 can be fabricated using a radio frequency (RF) sputtering process. Nanoparticle modification using RF sputtering can enable the particle size of the nanoparticles to be tuned, e.g., by adjusting the sputtering power. For example, a sputtering power of approximately 100 W can be used to form aggregates with a diameter less than approximately 20 nm, while a sputtering power of 200 W can be used to form aggregates with a diameter of approximately 200 nm.

The anode 110 with the nanoparticle-modified current collector 112 can be fabricated by assembling an electrochemical cell that includes the nanoparticle-modified current collector 112, a cathode with a layer of zinc deposited thereon, and an electrolyte and applying a reduction voltage to the nanoparticle-modified current collector 112 to strip the layer of zinc from the cathode and deposit the stripped zinc onto the nanoparticle-modified surface of the current collector 112 to form the anode 110 with the current collector 112 and the layer of zinc plating 114 (FIGS. 1B, 1C). The nanoparticles 116 can encourage planar growth of the zinc in the layer of zinc plating 114 while mitigating dendrite formation in the layer of zinc plating 114, thereby enabling increased zinc utilization and increased Coulombic efficiency relative to zinc anodes with unmodified current collectors. In some implementations, the Coulombic efficiency of the anode 110 with the nanoparticle-modified current collector 112 can exceed 99% after 1000 charging/recharging cycles. In some implementations, the layer of zinc plating 114 can be less than approximately 10 μm thick. For example, a thickness of the layer of zinc plating 114 can be approximately 1 μm, approximately 2 μm, approximately 3 μm, approximately 4 μm, or approximately 5 μm. In some implementations, a thickness of the layer of zinc plating 114 is less than approximately 1 μm.

In some implementations, as shown in FIG. 1A, an electrochemical cell can include a porous AC cathode 120 paired with any suitable anode 110 (e.g., a generic zinc anode). Similarly, in some implementations, as shown in FIG. 1B, an electrochemical cell can include an anode 110 with a nanoparticle-modified current collector 112 paired with any suitable cathode 120 (e.g., a generic carbon cathode). In some implementations, as shown in FIG. 1C, an electrochemical cell can include a porous AC cathode 120 paired with an anode 110 having a nanoparticle-modified current collector 112. Electrochemical cells that include both a porous AC cathode and an anode having a nanoparticle-modified current collector (e.g., the electrochemical cell 100C shown in FIG. 1C) can haven electrode capacity ratio (n/p) that is balanced (e.g., approximately equal to 1) or near-balanced (e.g., less than approximately 10).

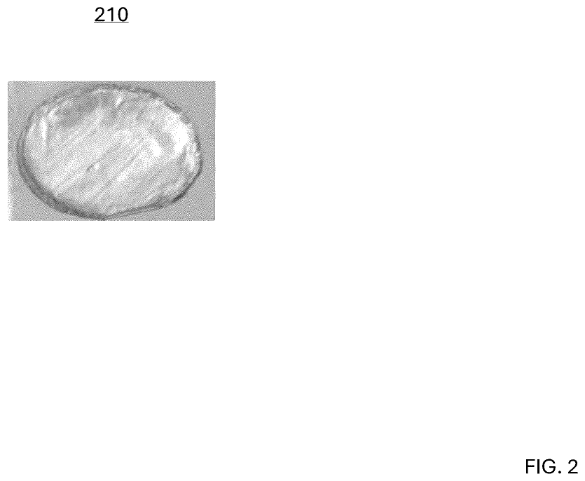

The fabrication techniques described herein can produce anodes and cathodes of various sizes and shapes. A photograph of an example anode 210 that was fabricated using the disclosed techniques is provided in FIG. 2. As shown, the anode 210 is substantially circular in shape. In the depicted implementation, the anode 210 has a diameter of approximately 1 cm.

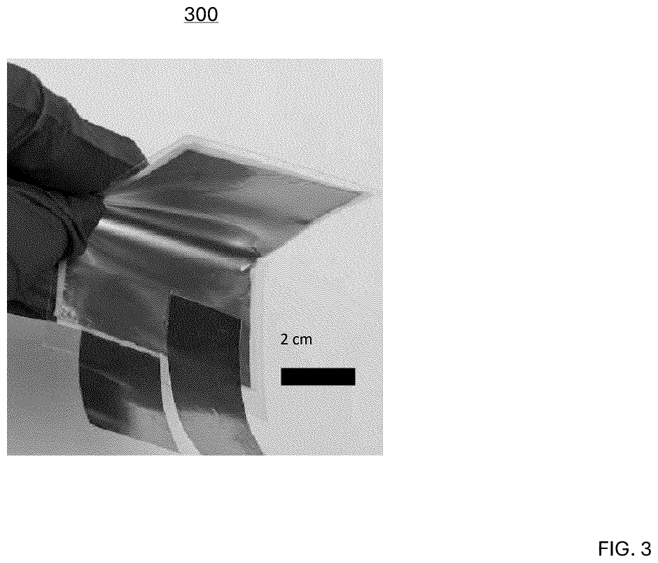

FIG. 3 shows a photograph of an example supercapacitor 300 that was fabricated using the disclosed techniques. The supercapacitor 300 is substantially rectangular in shape and has a width of approximately 4 cm and a length of approximately 5.5 cm. The cathode of the supercapacitor 300 includes 3.5 mg cm⁻² AC on a carbon cloth substrate. The anode of the supercapacitor 300 includes a copper current collector modified with copper nanoparticles (CuNPs) and 2.69 mg cm⁻² of active zinc. The electrolyte of the supercapacitor 300 includes 200 μL of 15 M ZnCl₂. The supercapacitor 300 has an electrode capacity ration (n/p) of 2.5 and a capacitance of 25.8 F.

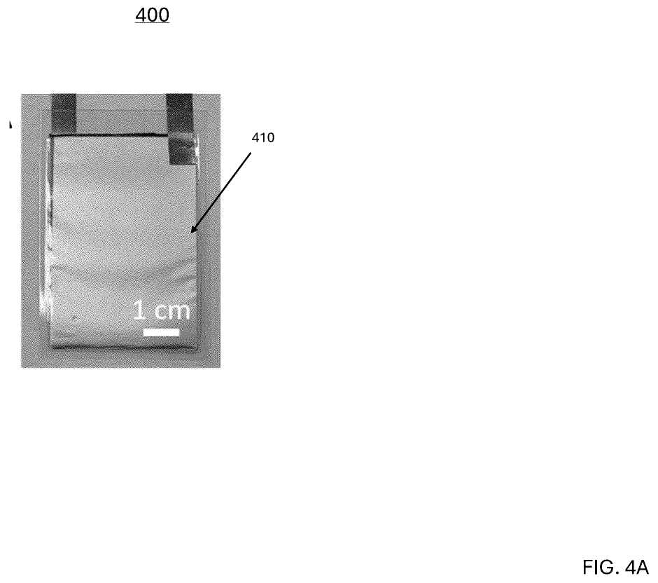

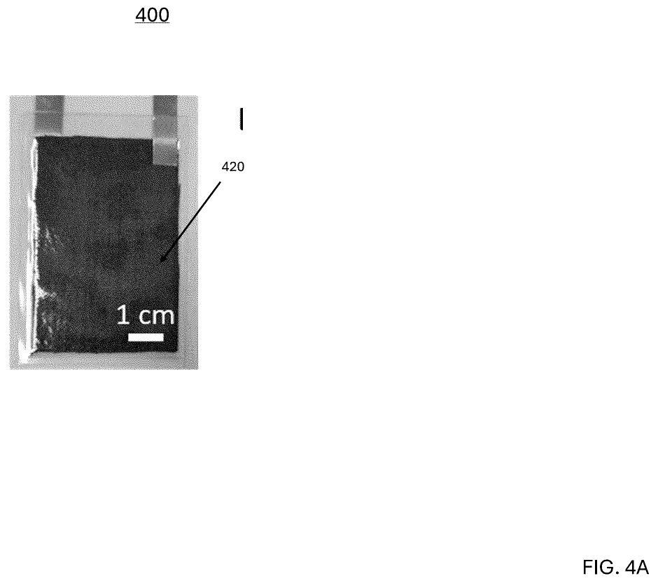

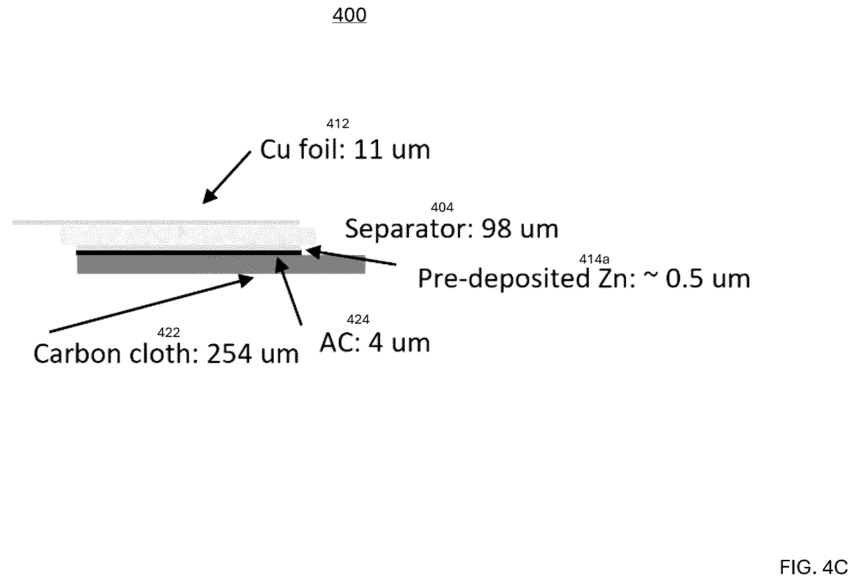

Photographs of an anode 410 and a cathode 420 of another example supercapacitor 400 are provided in FIGS. 4A-4B. The supercapacitor 400 is substantially rectangular in shape with sides that exceed 1 cm in length. The anode 410 (FIG. 4A) can include a zinc-plated copper foil current collector modified with copper nanoparticles. The cathode 420 (FIG. 4B) can include AC on a carbon cloth substrate. The supercapacitor 400 has a capacitance of 25.79 F and a capacity of 14 mAh.

FIG. 4C shows a cross-sectional diagram of the supercapacitor 400 prior to deposition of the zinc on the nanoparticle-modified copper foil current collector of the anode 410. As shown, the copper foil current collector 412 has a thickness of 11 μm. The current collector 412 is adjacent to a separator 404 that has a thickness of 98 μm. Adjacent to the separator 404 opposite the current collector 412 is a pre-deposited zinc layer 414a, which has a thickness of approximately 0.5 μm. The pre-deposited zinc layer 414a adjacent to an AC layer 424 of the cathode 420. The AC layer 424 has a thickness of 4 μm and is disposed on a carbon cloth substrate 422 that has a thickness of 254 μm.

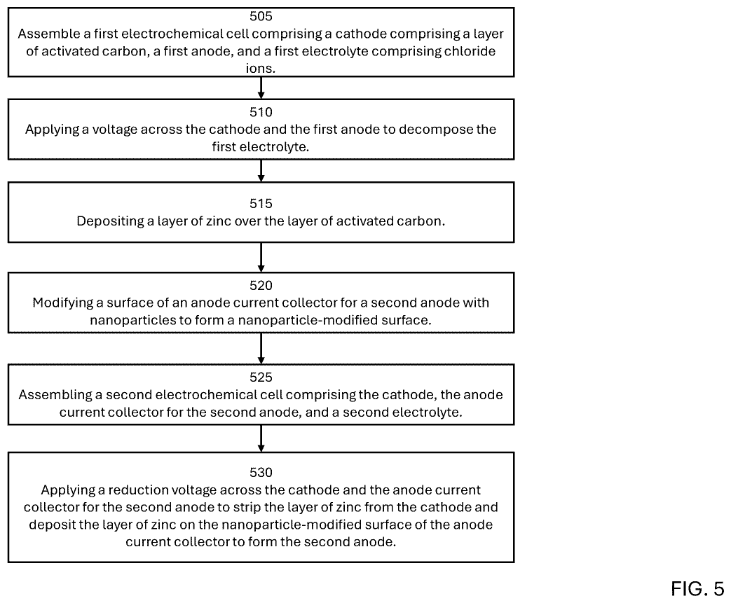

An exemplary method 500 of fabricating the disclosed electrochemical cells is provided in FIG. 5. The method 500 can enable the creation of electrochemical cells having a porous AC cathode and an anode with a nanoparticle-modified current collector such as, e.g., the electrochemical cell 100C shown in FIG. 1C, the supercapacitor 300 shown in FIG. 3, and the supercapacitor 400 shown in FIGS. 4A-4C. That is, the method 500 can enable the creation of electrochemical cells having a balanced or near-balanced electrode capacity ratio (n/p), high (e.g., >99%) Coulombic efficiency after numerous (e.g., >500) charge/recharge cycles, and high (e.g., >200 F g⁻¹) capacitance.

The method 500 of FIG. 5 is intended only as an example implementation of a method of fabricating the electrochemical cells disclosed herein. Those skilled in the art will appreciate that, in some implementations, portions of a method of fabricating an electrochemical cell can be executed in a different order than the method 500 of FIG. 5. Additionally, in some implementations, a method of fabricating an electrochemical cell can include portions that are not included in the method 500 of FIG. 5, and in some implementations, a method of fabricating an electrochemical cell can omit portions that are included in the method 500 of FIG. 5.

At 505, a first electrochemical cell that includes a cathode having an AC layer, a first anode, and a first electrolyte with chloride anions can be assembled. The AC layer of the cathode can be disposed on a substrate such as, e.g., a carbon cloth substrate. The first anode can be, e.g., a zinc foil anode (e.g., ThermoFisher, 011912-HG, 99.99%). The electrolyte can be, e.g., a zinc chloride electrolyte (e.g., 15 M ZnCl₂).

The cathode can be prepared using any suitable technique. In some implementations, AC (e.g. YP50F, 1600 m² g⁻¹, Kuraray) and carbon black (e.g., MTI, Lib-SP) powders can be ground together, for example, using a mortar and pestle. In some implementations, the weight ratio of AC to carbon black can be 7:2:1. The resulting powder slurry can be mixed with a solvent such as n-methylpyrrolidone (e.g., Sigma, 99.5%). Following mixing, the slurry can be coated on a surface of a carbon cloth substrate (e.g., AvCarb, 1071HCB), for example by screen printing with a doctor blade, and allowed to dry.

After the first electrochemical cell is assembled at 505, a voltage can be applied across the cathode and the first anode to decompose the first electrolyte into chlorine gas and activate the AC layer of the cathode (510). The chlorine gas can increase the porosity of the AC layer, forming a porous AC cathode having an increased capacitance relative to that of the cathode prior to decomposition of the first electrolyte at 510.

In some implementations, the voltage applied across the cathode and the first anode to decompose the first electrolyte into chlorine gas can be greater than approximately 0.1 V and less than approximately 5 V. For example, the voltage can be approximately 2 V, approximately 2.1 V, approximately 2.2 V, approximately 2.3 V, approximately 2.4 V, or approximately 2.5 V. In some embodiments, the voltage is greater than approximately 2.1 V. In some implementations, at 510, the first electrochemical cell can be charged and discharged between 1 V and 2.5 V versus Zn/Zn²⁺ at a constant current density of 26 mA cm⁻². This charging/discharging process can be continued until the Coulombic efficiency of first electrochemical cell stabilizes.

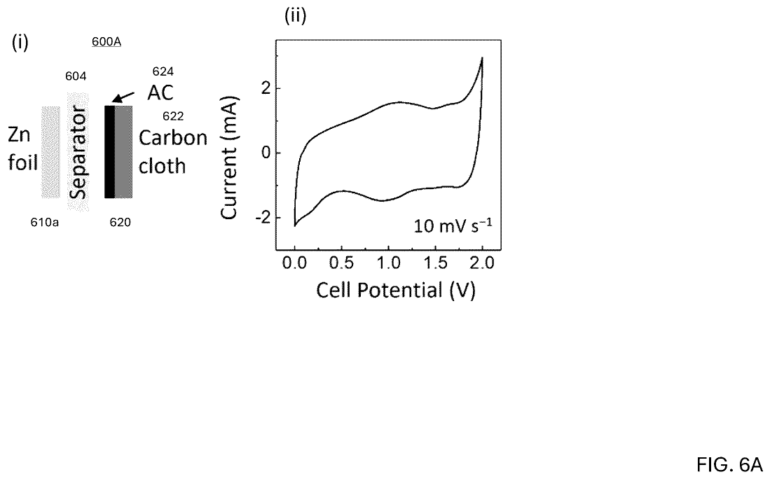

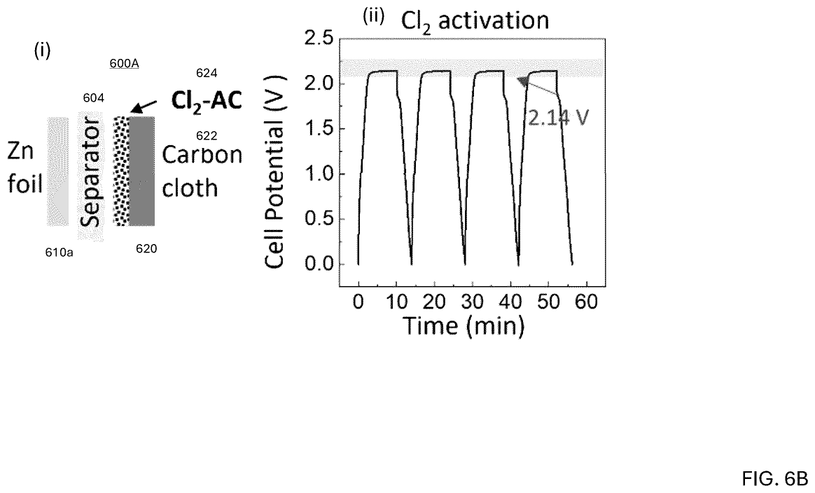

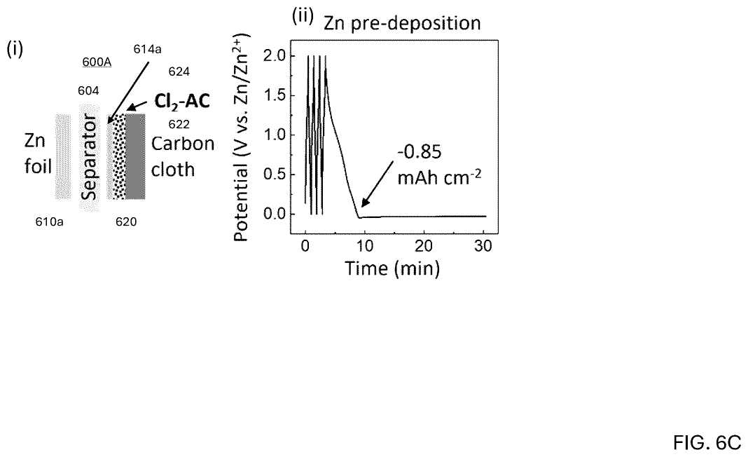

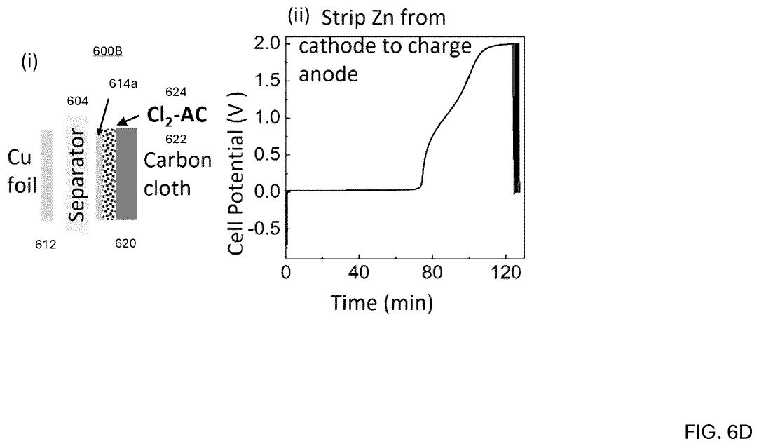

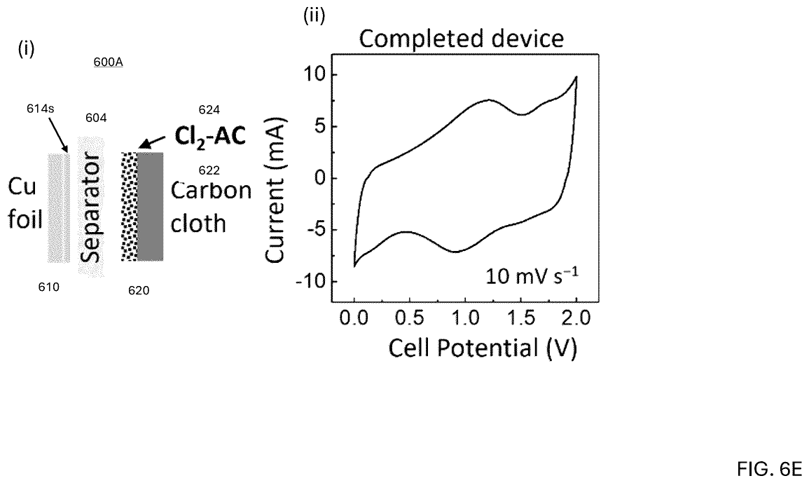

A diagram of an example first electrochemical cell 600A prior to activation of an AC layer 624 of its cathode 620 is illustrated in FIG. 6A(i) (e.g., prior to portion 510 of the method 500 shown in FIG. 5). As shown, the cell 600A includes the cathode 620, a separator 604, and a first anode 610a. The AC layer 624 of the cathode 620 is disposed on a carbon cloth substrate 622 of the cathode 620. The first anode 610a is a zinc foil anode. FIG. 6A(ii) shows a cyclic voltammetry curve for one implementation of the cell 600A.

FIG. 6B(i) shows a diagram of the first electrochemical cell 600A following activation of the AC layer 624 of the cathode 620 by chlorine gas (e.g., following portion 510 of the method 500 shown in FIG. 5). As illustrated, the chlorine gas activation increases the porosity of the AC layer 624. A plot of cell potential over time for one implementation of the cell 600A during activation of the cell's AC cathode inside a zinc chloride electrolyte is provided in FIG. 6B(ii). In this implementation, chlorine gas evolution starts by approximately 2.14 V.

Referring again to FIG. 5, following decomposition of the first electrolyte at 510, a layer of zinc can be deposited over the layer of porous AC of the cathode (515). The zinc layer can be deposited using any suitable deposition technique. The first electrochemical cell can then be disassembled to remove the first anode.

A diagram of the electrochemical cell 600A following deposition of a zinc foil 614a to the cathode 620 (e.g., following portion 515 of the method 500 shown in FIG. 5) is illustrated in FIG. 6C(i). As shown, the zinc foil 614a is applied to the chlorine-activated AC layer 624 of the cathode 620. FIG. 6D(ii) shows a plot of the potential of one implementation of the cell 600A over time during deposition of zinc foil (zinc plating) to the AC cathode of the cell.

Referring again to FIG. 5, at 520, a surface of an anode current collector for a second anode can be modified with nanoparticles to form a nanoparticle-modified surface. The current collector can be, e.g., a copper current collector and the nanoparticles can be, e.g., copper nanoparticles. The nanoparticles can be deposited onto the surface of the current collector using any suitable deposition process. In some implementations, the nanoparticles can be deposited by radio frequency (RF) sputtering. RF sputtering can enable uniform nanoparticle deposition over large (e.g., >10 cm²) areas in short periods of time (e.g., a few minutes), which can allow the nanoparticle modification process to be scaled to efficiently produce modified current collectors of various sizes.

At 525, a second electrochemical cell that includes the porous AC cathode with the zinc layer produced at 515, the nanoparticle-modified anode current collector produced at 520, and a second electrolyte can be assembled. This second electrochemical cell, at 525, may be considered “anode-free” because its anode is incomplete, that is, its anode includes only the current collector for the second anode. The anode can be completed, at 530, by applying a reduction voltage across the porous AC cathode and the nanoparticle-modified current collector to strip the layer of zinc from the porous AC cathode and deposit the layer of zinc on the nanoparticle-modified surface. The resulting second anode can be a zinc-plate nanoparticle modified current collector.

FIG. 6D(i) illustrates a diagram of an example second electrochemical cell 600B during the cell's “anode-free” stage. As shown, the second electrochemical cell 600B includes the porous AC cathode 620 and a copper foil current collector 612 for a to-be-formed second anode. The copper foil current collector 612 is modified with copper nanoparticles. The cathode 620 includes the chlorine-activated AC layer 624, the carbon cloth substrate 622, and the layer of zinc 614a shown in FIG. 6C(i). A plot of the cell potential of one implementation of the cell 600B over time during stripping of the zinc foil (reverse zinc plating) from the AC cathode and deposition of the zinc foil on the copper current collector (e.g., during the portion 525 of the method 500 shown in FIG. 5) is shown in FIG. 6D(ii).

A diagram of the completed second electrochemical cell 600B (e.g., the electrochemical cell 600B following the portion 525 of the method 500 shown in FIG. 5) is illustrated in FIG. 6E(i). As shown, the completed electrochemical cell 600B includes a fully formed anode 610 that includes the copper nanoparticle-modified copper current collector 612 and a layer of zinc 614 formed from the layer of zinc 614a that had been disposed on the AC cathode (FIG. 6D(i)). The completed electrochemical cell 600B also includes the cathode 620, which includes the carbon cloth substrate 622 and the porous AC layer 624. FIG. 6E(ii) shows a cyclic voltammetry curve of one implementation of the completed cell 600B.

### Porous AC Cathode Fabrication and Characteristics

The increased capacitance of the disclosed electrochemical cells results (at least in part) from the layer of porous AC carbon in the cathode. AC is generally low-cost, is capable of supporting fast kinetics, and enables high charging/discharging current densities known to inhibit dendrite growth. However, commercially available AC typically has a lower gravimetric capacity than higher-cost specialty carbon materials (e.g., graphene, carbon nanotubes, etc.), oxides (e.g., ZnV₂O₅), and redox polymers. To improve the cathode capacity, the AC porosity can be increased through a gas-evolution reaction, e.g., in a concentrated 15 M ZnCl₂ electrolyte. This treatment can circumvent high-temperature oxidation using molten alkali oxidants in typical carbon activation and allows for the use of “water-in-salt” (WIS) ZnCl₂ as the electrolyte in the completed electrochemical cell. As a result of the improved capacity of the AC cathode, the electrode capacity (n/p) ratio of the completed electrochemical cell can be balanced or near-balanced (e.g., <10).

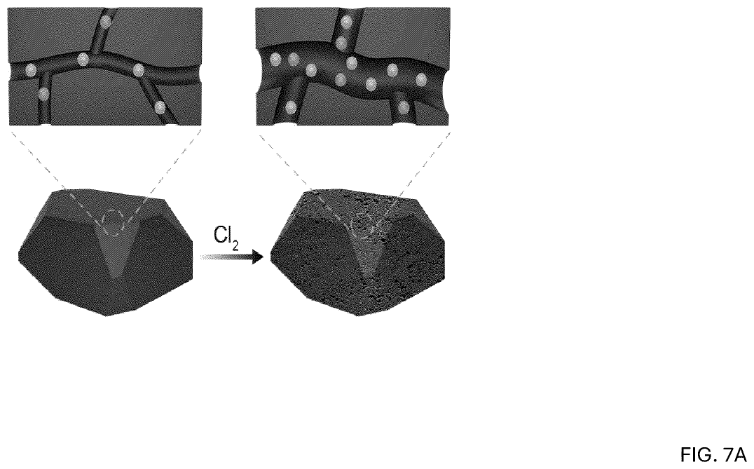

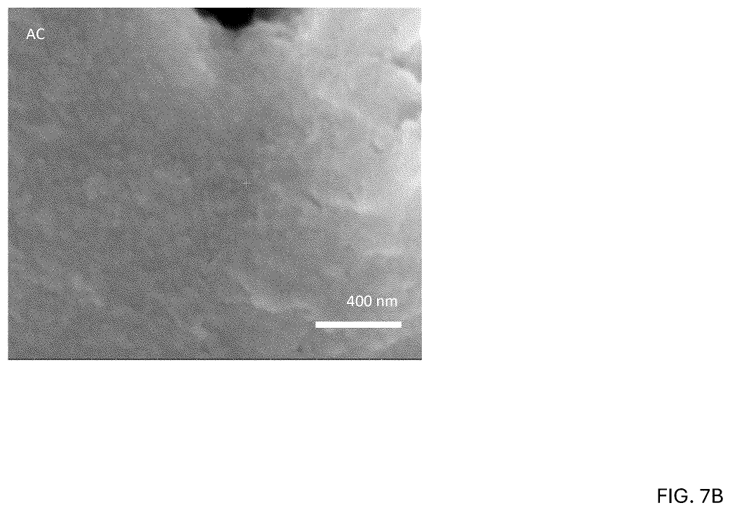

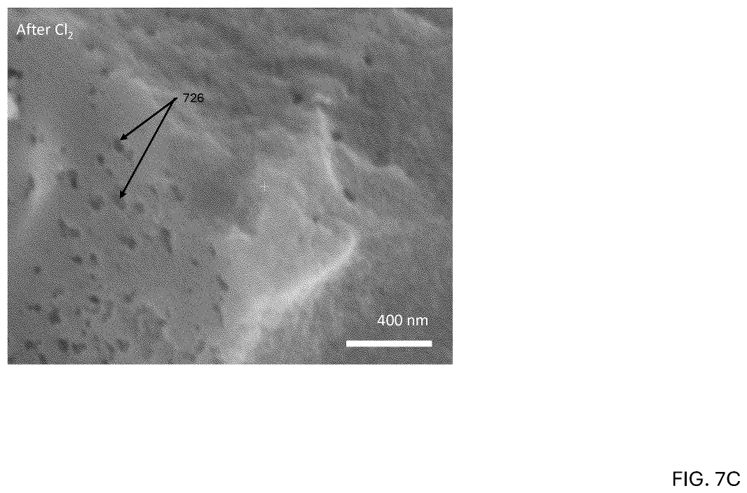

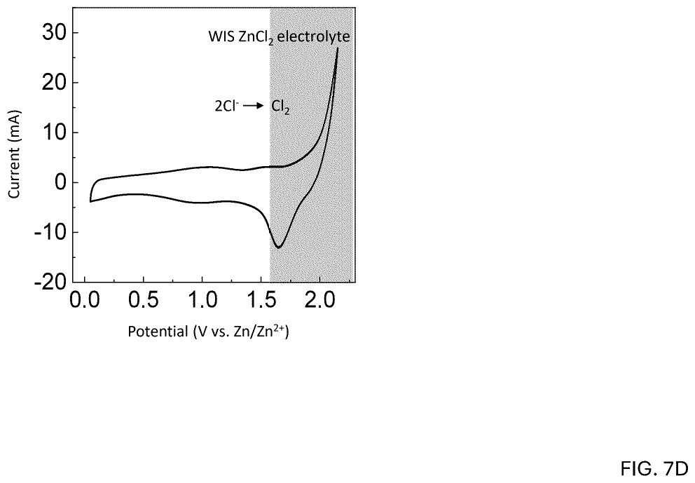

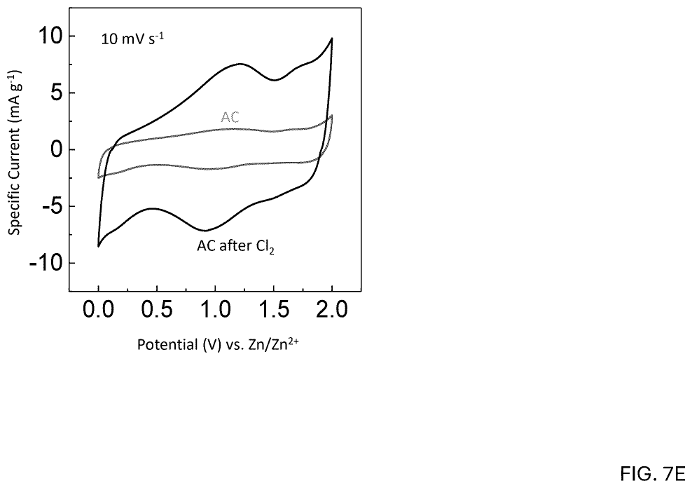

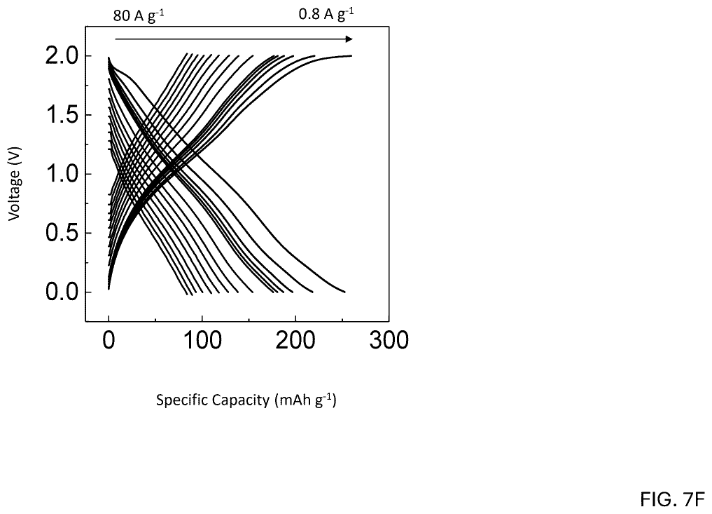

In some implementations, the activated carbon on cathode can be prepared by processing a commercial AC by an additional activation step that involves decomposing a 15 M ZnCl₂ electrolyte. As shown in FIG. 7A, activation of AC by chlorine gas (Cl₂) produced by decomposing the ZnCl₂ electrolyte can increase the radius of pores in the AC. The electrolyte used to activate the AC can be discarded following decomposition and replaced with a fresh electrolyte when the completed cell is assembled.

### Example 1

FIGS. 7B-7F show example data illustrating various characteristics of one example AC cathode before, during, and following its activation by chlorine gas.

SEM images of the example AC cathode prior to activation by chlorine gas and following activation by chlorine gas are provided in FIGS. 7B and 7C, respectively. As shown in FIG. 7C, following activation, the AC includes a plurality of pores 726. The pores 726 can be at least 1 nm in radius.

A cyclic voltammetry curve for the example AC cathode during activation by chlorine gas is provided in FIG. 7D. For this example, repeated cycling between 1 V and 2.5 V was performed 1000 times at a constant current of 26 mA cm⁻². As shown in FIG. 7D, when applied voltage on the cathode exceeded 2 V, a pronounced oxidation peak appeared, corresponding to the oxidation of Cl-ions in the ZnCl₂ electrolyte into Cl₂ gas that would expand the porosity in the AC cathode.

FIG. 7E shows cyclic voltammetry curves for the example AC cathode before and after activation by chlorine gas. The cyclic voltammetry was performed at a scan rate of 10 mV s⁻¹. As shown, following the Cl₂ activation process, the electrode capacitance increased from 114 F g⁻¹ up to 417 F g⁻¹.

A plot of gravimetric capacity for the AC cathode following chlorine activation is provided in FIG. 7F. Capacity-voltage profiles of the Cl₂-activated cathode at various charge/discharge current ranging from 0.8 A g⁻¹ to 80 A g⁻¹ are shown.

### Example 2

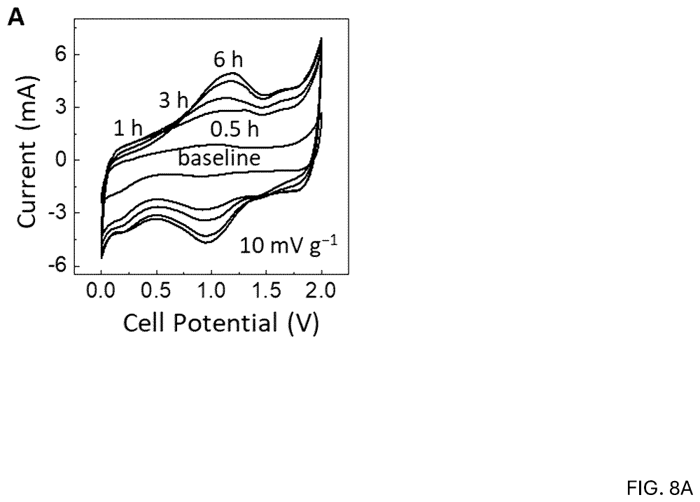

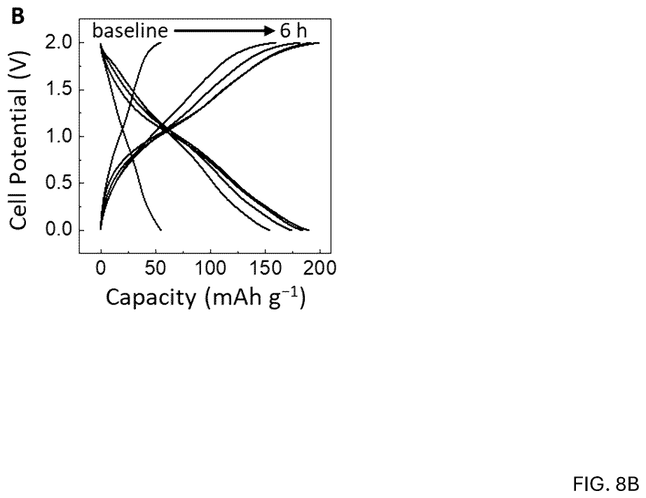

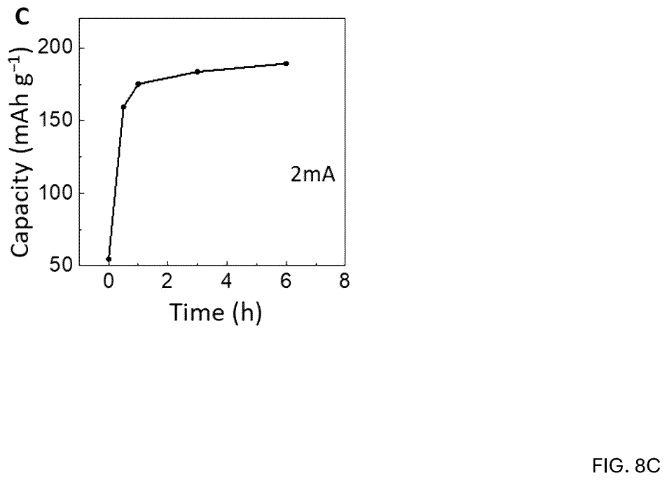

FIGS. 8A-8C show example data illustrating various characteristics of another example AC cathode before, during, and following activation by chlorine gas.

In FIGS. 8A-8B, cyclic voltammetry curves (FIG. 8A) and capacity-voltage profiles (FIG. 8B) of chlorine-activated AC measured in 15 M ZnCl₂ electrolyte are shown for the following activation periods: 0 h, 0.5 h, 1 h, 3 h, and 6 h, demonstrating the effect of activation time on porosity. FIG. 8C shows a plot of the capacity change of the example AC cathode over time. In this example, the capacity of the AC increased rapidly during the first two hours of Cl₂ activation process before plateauing in the third hour.

### Example 3

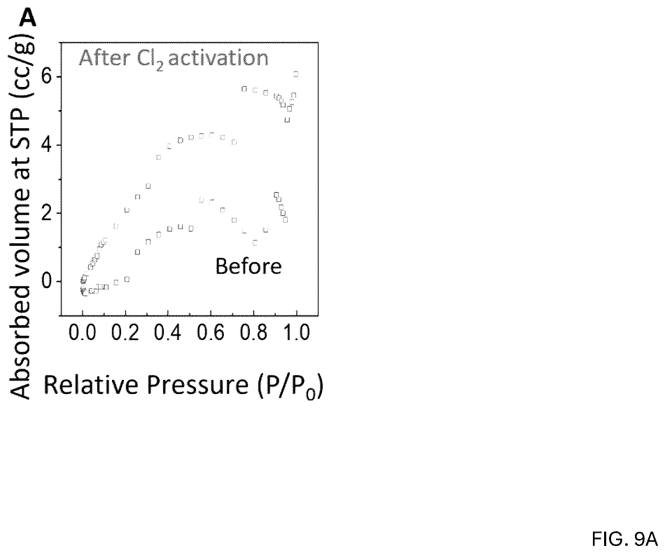

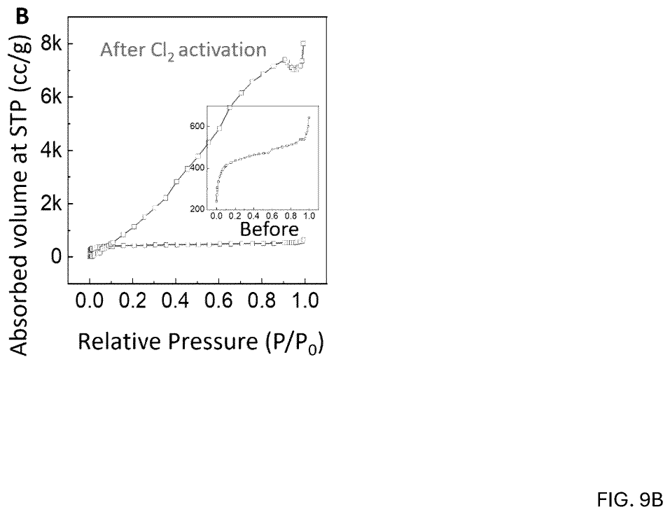

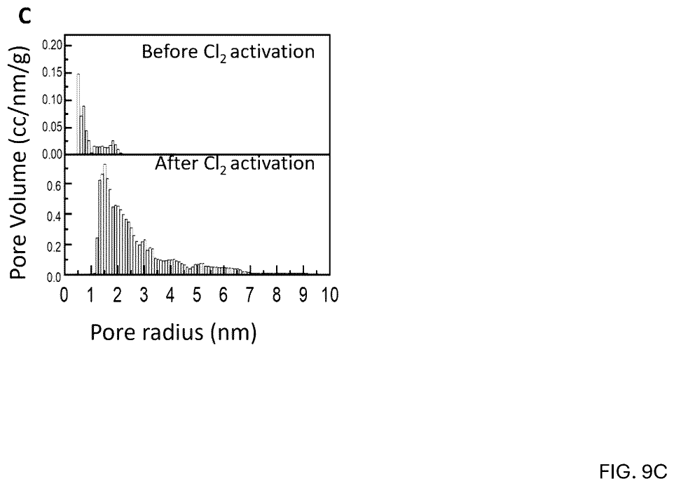

FIGS. 9A-9C show example data illustrating various characteristics of another example AC cathode before and after activation by chlorine gas. In this example, the AC cathode includes an AC layer on a carbon cloth substrate.

In FIGS. 9B, a Brunauer-Emmett-Teller (BET) analysis estimate, before and after activation by the chlorine gas, of electrode porosity for the example AC electrode is provided. In this example, the active surface area of the AC on the carbon cloth substrate was measured to be 1670 m² g⁻¹ prior to activation. This active surface area increased by a factor 3.4 to 5750 m² g⁻¹ following chlorine activation. For comparison, a Brunauer-Emmett-Teller (BET) analysis estimate of electrode porosity for a bare carbon cloth substrate before and after activation by chlorine gas is provided in FIG. 9A.

FIG. 9C provides histograms of pore radius distribution, before and after activation by the chlorine gas, of the example AC electrode. As shown in FIG. 9C, the pore radius of this example cathode expanded to >1 nm following chlorine activation.

### Example 4

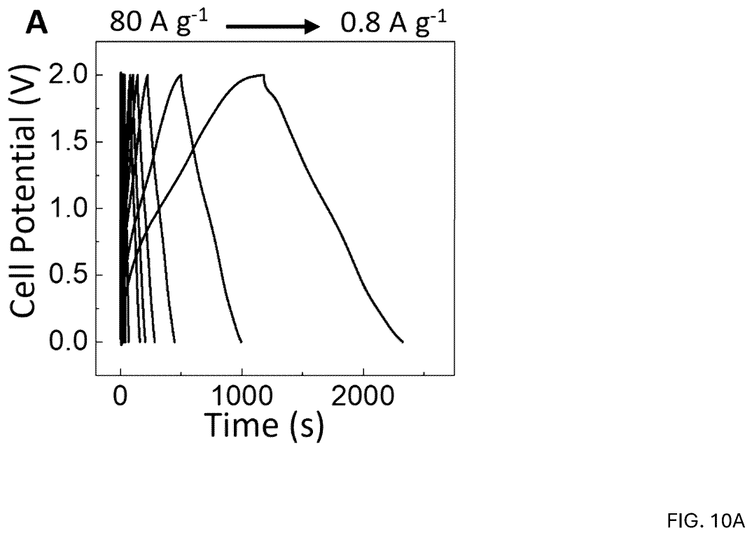

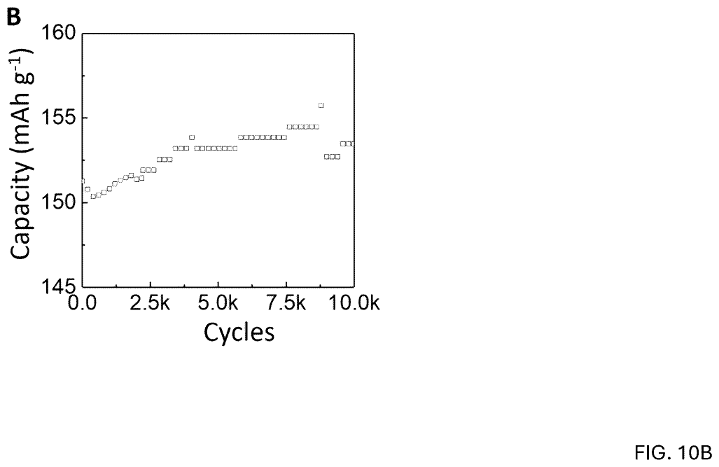

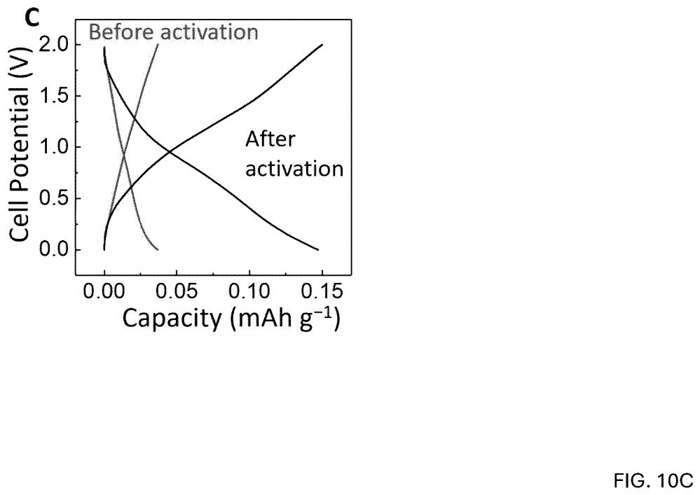

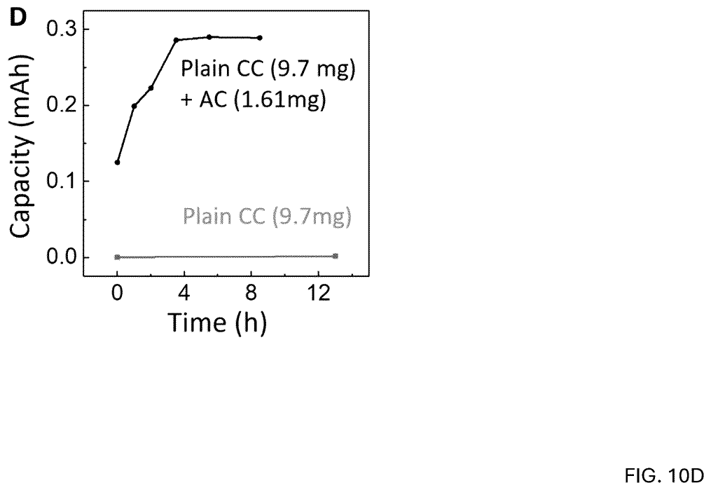

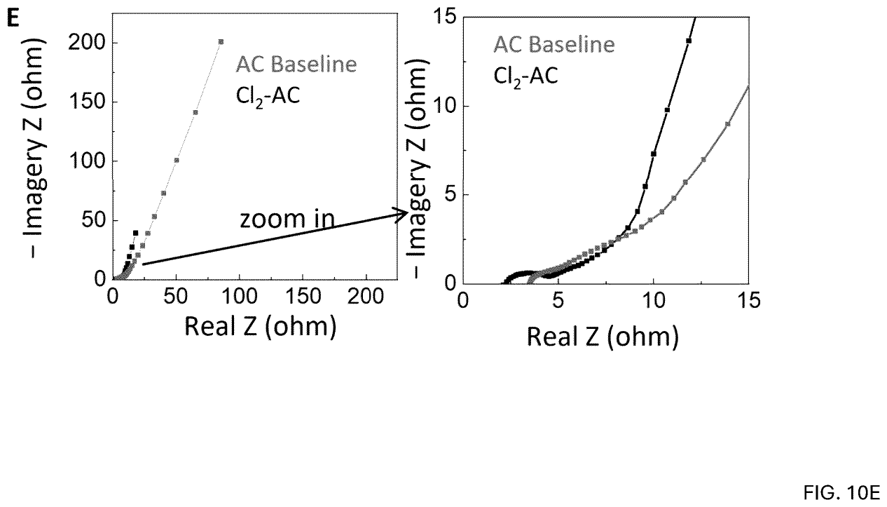

FIGS. 10A-10E show example data illustrating various characteristics of another example AC cathode, following activation by chlorine gas. In this example, the AC cathode includes a layer of AC on a carbon cloth substrate. After Cl₂ activation, the specific capacity of the carbon cloth substrate was measured to be 0.147 mAh g⁻¹, negligible compared to the specific capacity of the AC. At a low current density of 1 mA cm 2, equivalent to 0.8 A g⁻¹, the capacity of this example AC cathode was 256 mAh g⁻¹. When the applied current density was increased by a factor of 100 (to 102 mA cm 2 or 80 A g⁻¹), the capacity of this example cathode still reached 84 mAh g⁻¹, allowing the AC to deliver high energy even at large power output. This example cathode also maintained 100% of its capacity after 10,000 charge-discharging cycles between 0 and 2 V. In other words, the stability of the AC was unaffected by the Cl₂ activation step.

FIG. 10A provides voltage profiles of the example Cl₂-activated AC cathode at various charge/discharge current ranging from 0.8 A g⁻¹ to 80 A g⁻¹. Charging/discharging stability test data for the example Cl₂-activated AC cathode is shown in FIG. 10B. In this test, the voltage was between 0 and 2 V and the current density was 80 A g⁻¹. FIG. 10C shows capacity-voltage profiles of bare carbon cloth and Cl₂-activated carbon cloth measured at a current density of 2 mA. FIG. 10C shows capacity versus activation time, on samples of plain carbon cloth and carbon cloth with active carbon. FIG. 10E shows Imaginary impedance versus real impedance of AC before and after Cl₂ activation, measured at 1 V versus a Zn/Zn²⁺ reference.

### Nanoparticle-Modified Anode Fabrication and Characteristics

The “initially anode-free” structure of the electrochemical cells described herein, in which the electrode starts out with a current collector only (excluding redox-active or host materials), can reduce the amount of zinc in the anode. During fabrication of the anode, metal ions from an electrolyte or a cathode can be deposited onto a current collector for the anode. These metal ions can form a thin metal layer on the current collector that serves as the active material for subsequent redox cycles. This initially anode-free design can eliminate the use of thick metal foils and offer straightforward adjustment of anode capacity through tuning the deposition time.

Dendrite formation in the zinc layer that is deposited on the anode current collector can diminishes the limited supply of active zinc, potentially leading to short circuits and failure of the electrochemical cell. Such undesirable dendrite formation can be mitigated by facilitating planar, compact grain growth of the Zn(002) facet. The electrochemical cell fabrication techniques disclosed herein leverage a simple and scalable process for encouraging such planar, compact grain growth that involves modifying the current collectors with sputtered copper nanoparticles. In some implementations, a surface of current collector (e.g., a copper current collector) can be modified with nanoparticles (e.g., copper nanoparticles (CuNPs)) deposited by radio-frequency (RF) sputtering.

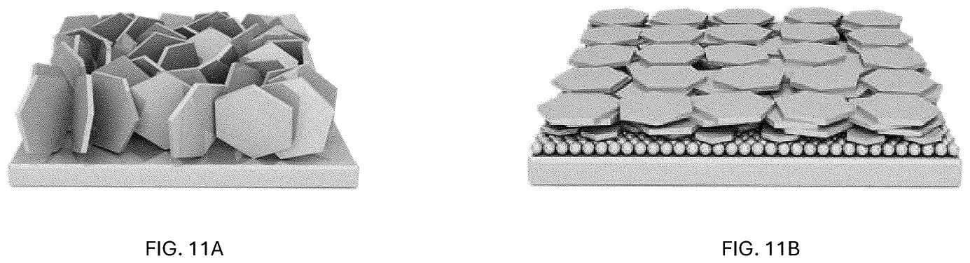

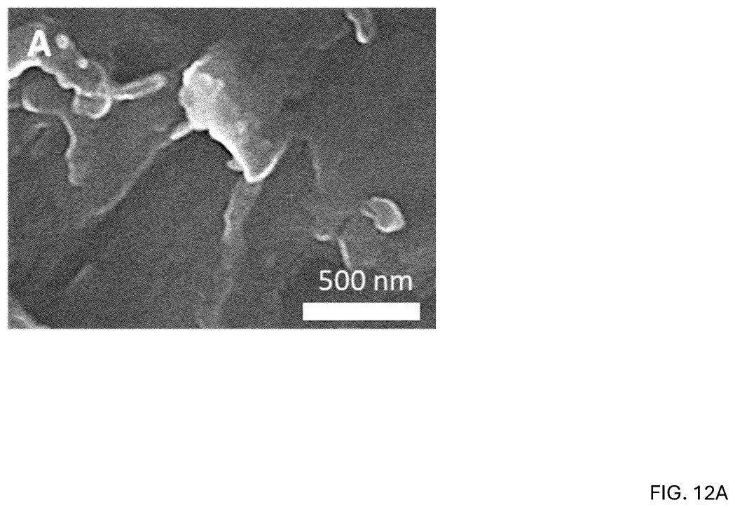

The effect of the provided fabrication techniques on dendrites in a zinc layer of an anode is illustrated in FIGS. 11A-11B. Substantial dendrite formation occurred in zinc layers deposited on an unmodified anode current collector (FIG. 11A). Modification of the anode current collector with copper nanoparticles resulted in increased growth of the Zn(002) facet (FIG. 11B).

### Example 5

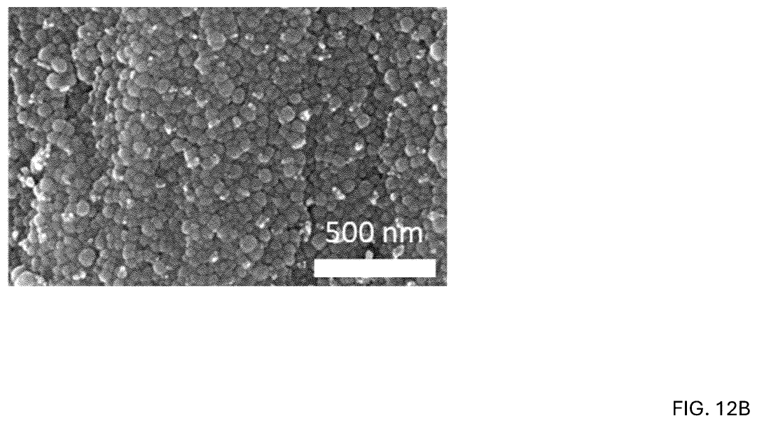

FIGS. 12A-12B show scanning electron microscopy (SEM) images of an example copper foil surface before (FIG. 12A) and after sputtering with CuNPs (FIG. 12B). Specifically, FIG. 12B shows a SEM image of the copper foil surface after sputtering with CuNPs for 3 minutes at 100 W power.

### Example 6

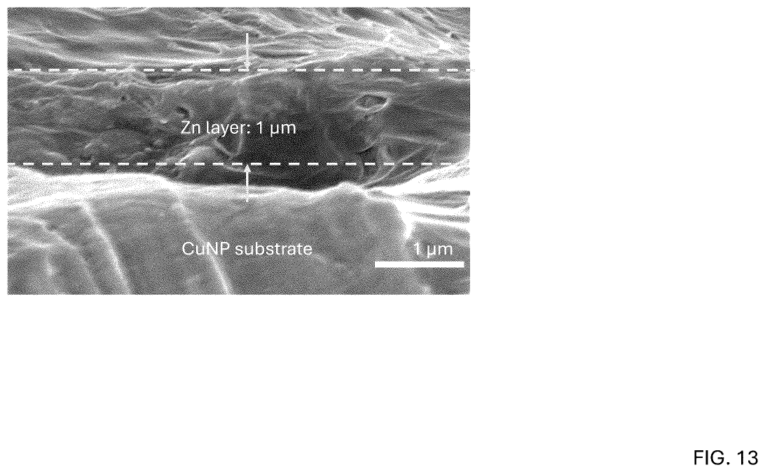

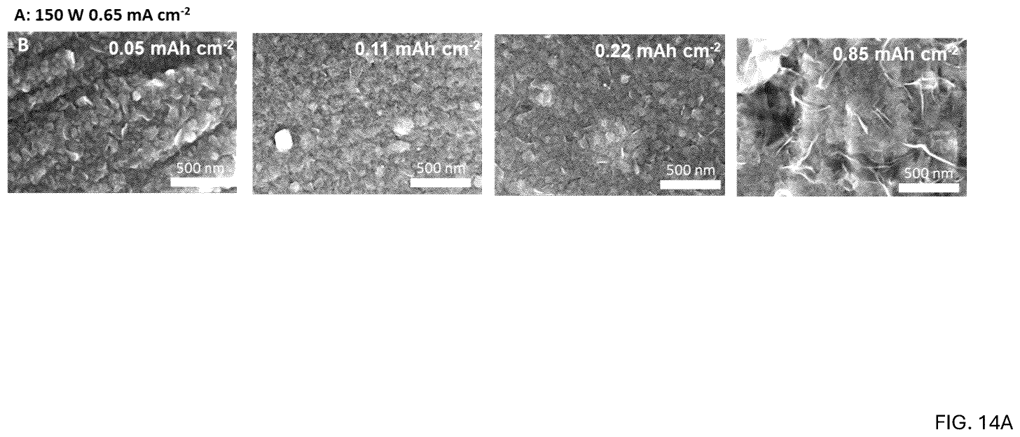

FIG. 13 shows a SEM image of a cross-section of an example nanoparticle-modified zinc anode. In this example, the anode includes a layer of zinc deposited on a CuNPs-modified copper current collector. The layer of zinc is approximately 1 μm thick.

### Example 7

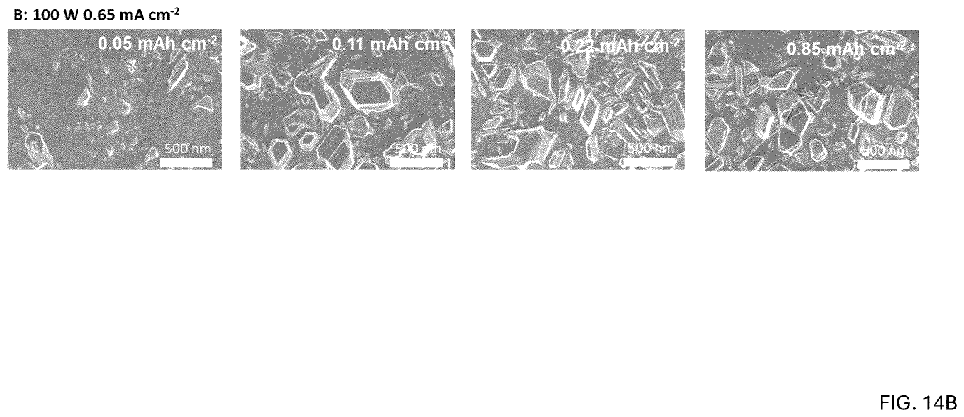

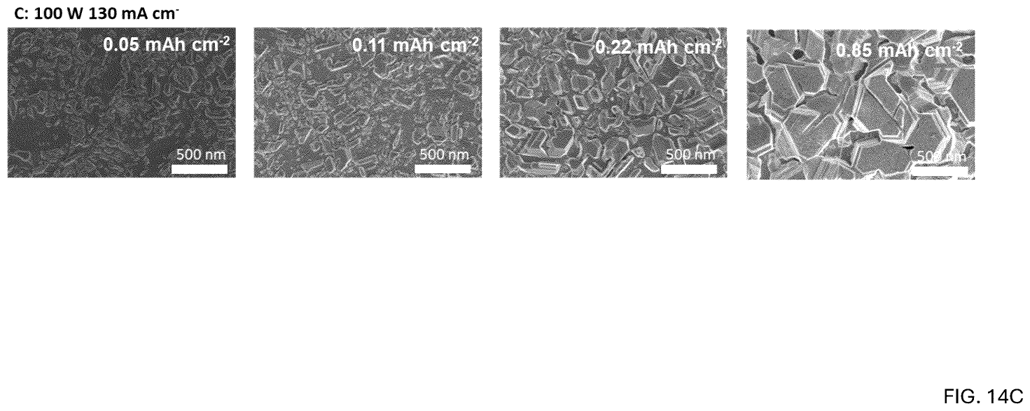

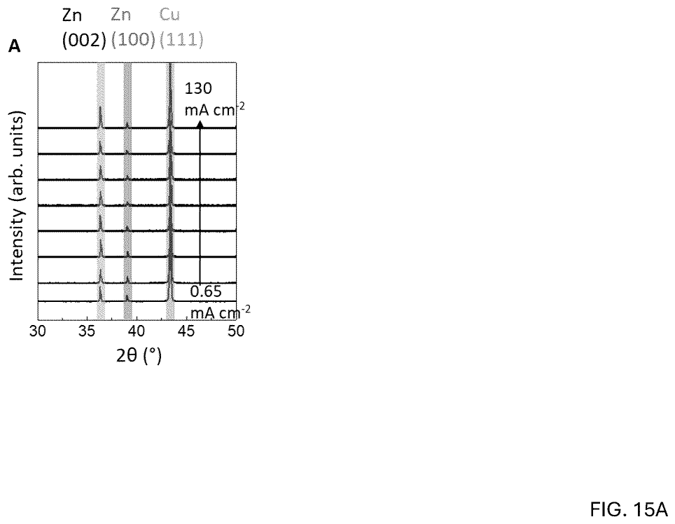

FIGS. 14A-14C show SEM images of zinc layers on a deposited at various current densities on various nanoparticle-modified copper current collectors. In FIG. 14A, the zinc was deposited at a current density of 0.65 mA cm⁻² on a copper current collector sputtered with CuNPs at 150 W. In FIG. 14B, the zinc was deposited at a current density 0.65 mA cm⁻² on a copper current collector sputtered with CuNPs at 100 W. In FIG. 14C, the zinc was deposited at a current density of 130 mA cm⁻² on a copper current collector sputtered with CuNPs at 100 W. As shown by the different grain morphologies, the different current densities and nanoparticle modification powers led to different I(002)/I(100) ratios.

### Example 8

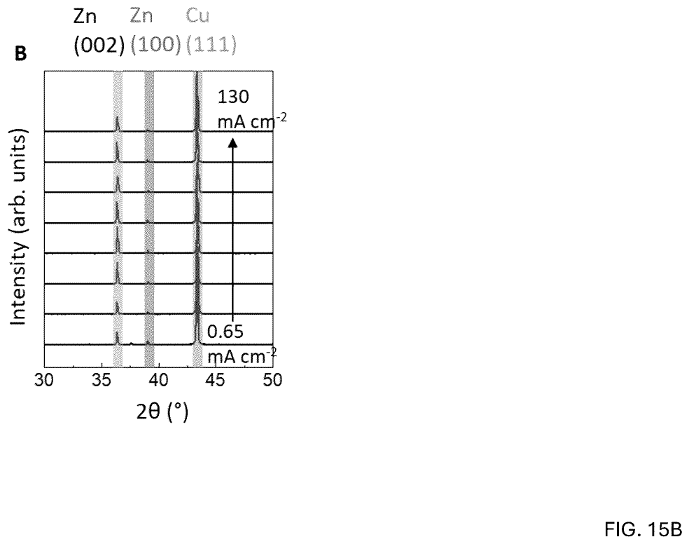

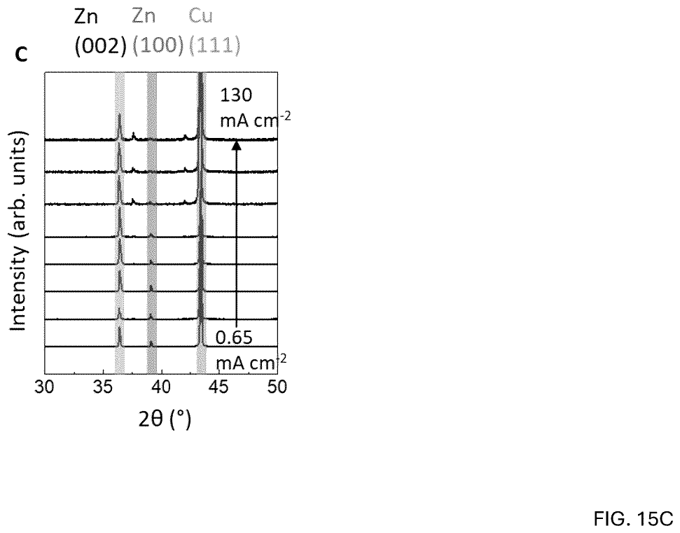

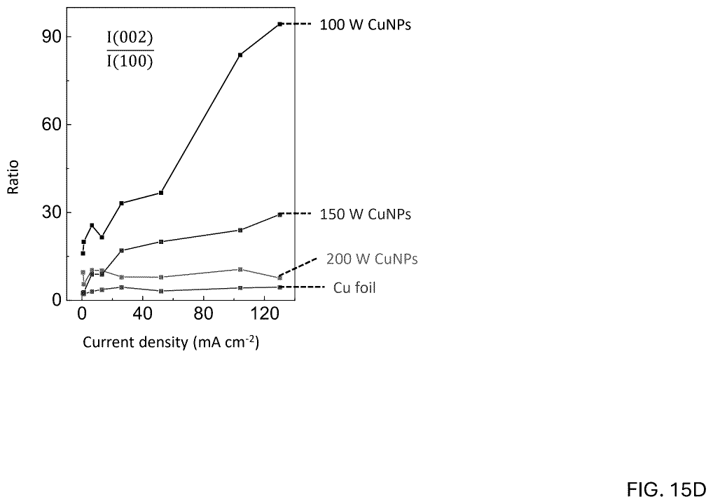

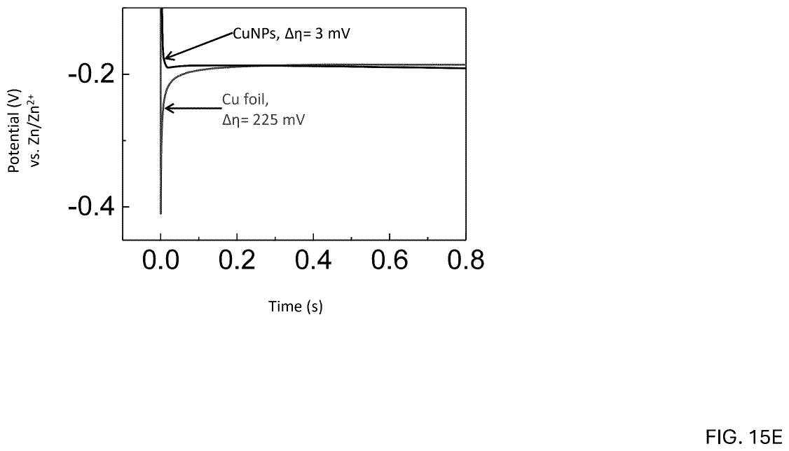

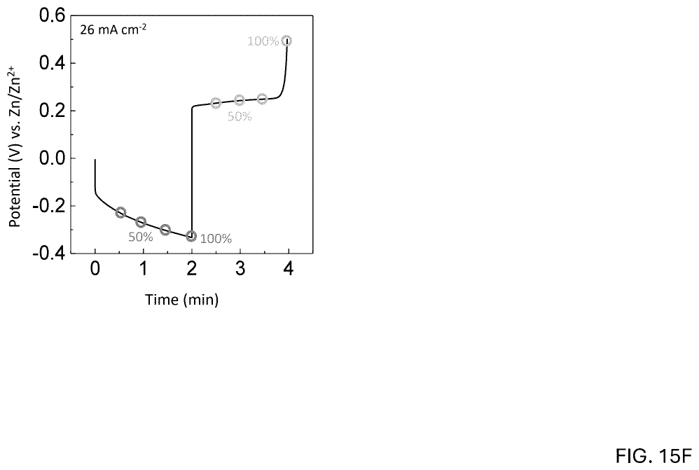

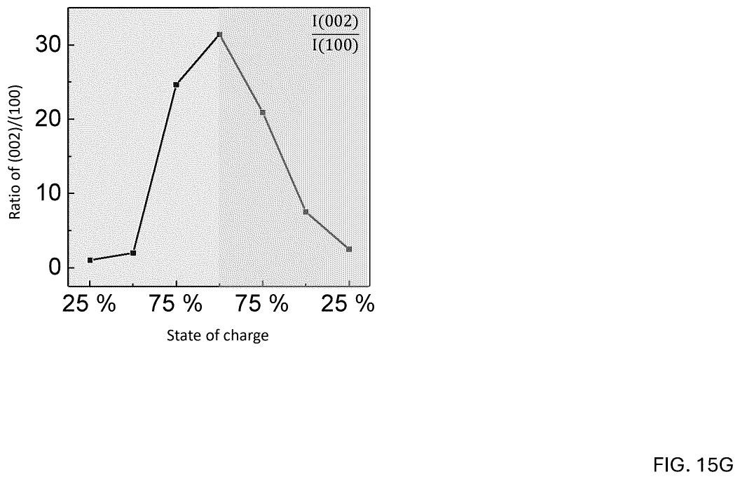

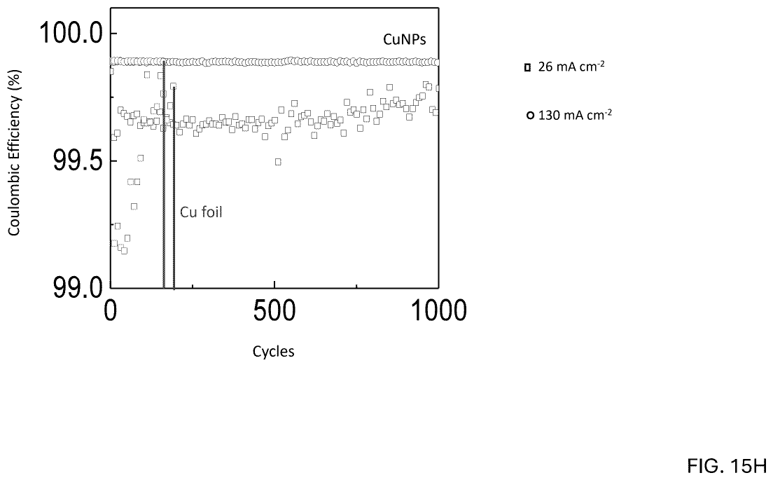

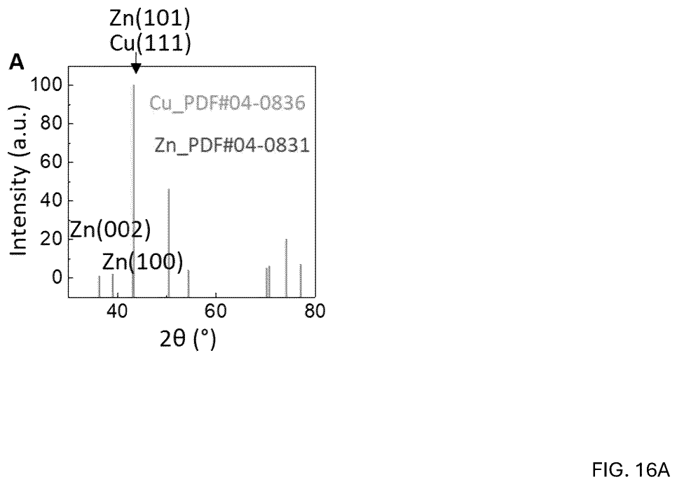

FIGS. 15A-15H show example data illustrating characteristics of an example nanoparticle-modified anode during and following fabrication. The example anode includes a copper current collector sputtered with CuNPs at 200 W.

FIG. 15C shows an example of x-ray diffraction (XRD) patterns measured on the example anode following zinc plating at the following current densities: 0.65, 1.3, 6.5, 13, 26, 52, 104, and 130 mA cm⁻². For comparison, XRD patterns measured for zinc plating on an unmodified foil and on a 150 W sputtered CuNPs on Cu foil at the aforementioned current densities are provided in FIGS. 15A and 15C, respectively.

FIG. 15D shows a plot of the ratio of peak intensity I(002)/I(100) for the example anode (labeled “200 W CuNPs” in FIG. 15D) and other example anodes. As shown, the I(002)/I(100) ratio was at its minimum on the bare (e.g., unmodified) copper current collector (labeled “Cu foil” in FIG. 15D). The ratio increased upon modification by sputtering CuNPs, with the smallest CuNPs deposited at the lowest RF power leading to the highest ratio (“100 W CuNPs”). This trend indicates a strong orientation effect from the CuNPs promoting zinc electro-crystallization in the (002) plane over (100), providing a handle to encourage compact planar growth reduce dendrites in (100) and (101) orientations during zinc plating.

In this example, the sputtered CuNPs directed a preference to (002) growth parallel to the current collector substrate despite being randomly oriented without well-defined crystal facets. The CuNPs provided additional nucleation sites which lowered the plating overpotential Δη, defined as the potential difference between nucleation and growth processes. As shown in FIG. 15E, the Δη for zinc deposition on an anode with CuNPs was just 3 mV, significantly less than the 225 mV observed on bare, unmodified copper. This suggests that it was energetically favorable for zinc to nucleate and grow laterally on CuNPs across the surface, resulting in (002) horizontal platelets. In contrast, the substantial potential barrier for nucleation on bare copper led to vertical growth and a low I(002)/I(100) ratio, as shown in FIG. 15D.

The reversible electrical and morphological characteristics of the example anode are presented in FIGS. 15F and 15G, measured after 1000 plating/stripping cycles at a current density of 26 mA cm⁻². As shown, at the beginning of zinc deposition with the anode at a state-of-charge (SOC) of 25%, the I(002)/I(100) ratio was 1.03. The ratio increased to 31.4 by the time the SOC reached 100%. During the stripping process, the I(200)/I(100) returned to 1 when the SOC decreased to 0%. These data indicate that preferential (002) deposition persisted even after an extensive 1000 cycles, conducted at 100% utilization of the deposited zinc.

As shown in FIG. 15H, the Coulombic efficiency (C.E.) for the example anode was 99.6% (squares, 26 mA cm⁻²) to 99.9% (circles, 130 mA cm⁻²) after 1000 cycles, while an anode with a bare (e.g., unmodified) copper current collector short-circuited after just 200 cycles, irrespective of the applied current densities being high or low. This indicates that nanoparticle modification of the anode current collector can extend the lifetime of the anode, significantly improved cycling stability, enable reduced zinc usage, and provide a more balanced n/p ratio in a full cell.

### Example 9

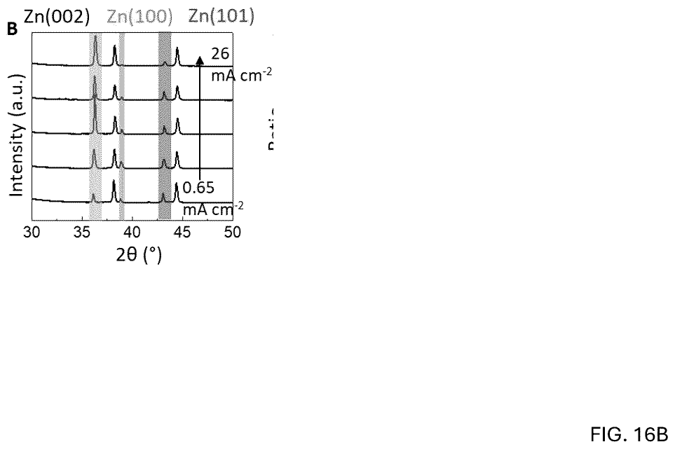

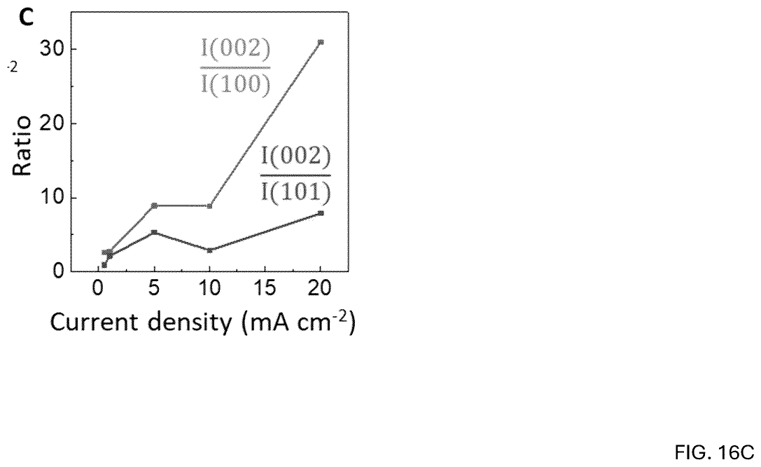

In this example, crystal facets in electrodeposited zinc layers were analyzed using different current collectors. FIGS. 16A-16B show XRD peaks of reference Cu (PDF #04-0836) and Zn foils (PDF #04-0831) (FIG. 16A) and zinc electrodeposition at different current densities (0.65, 1.3, 6.5, 13, 26 mA cm⁻²) (FIG. 16B) on a graphite surface modified with copper nanoparticles through RF sputtering at 150 W for 3 min. FIG. 16C shows a plot of the ratio of x-ray peaks versus electrodeposition current density in FIG. 16B. As shown, the peak intensity ratios I(002)/I(100) and/(002)//(101) followed the same trend, indicating that either ratio would work well for monitoring the zinc facets.

### Example 10

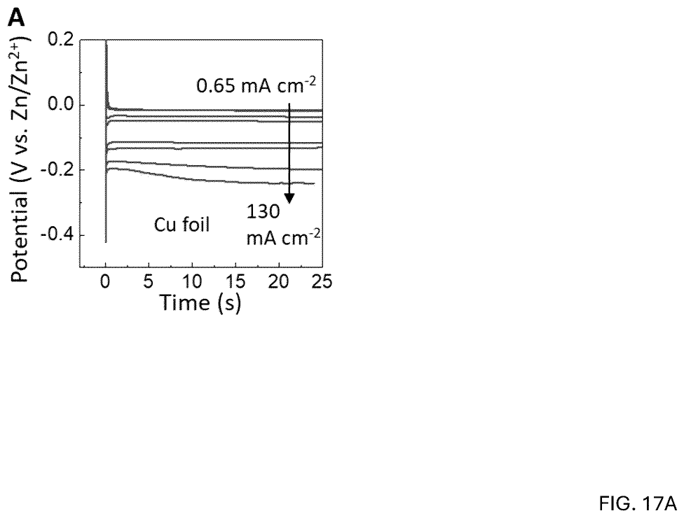

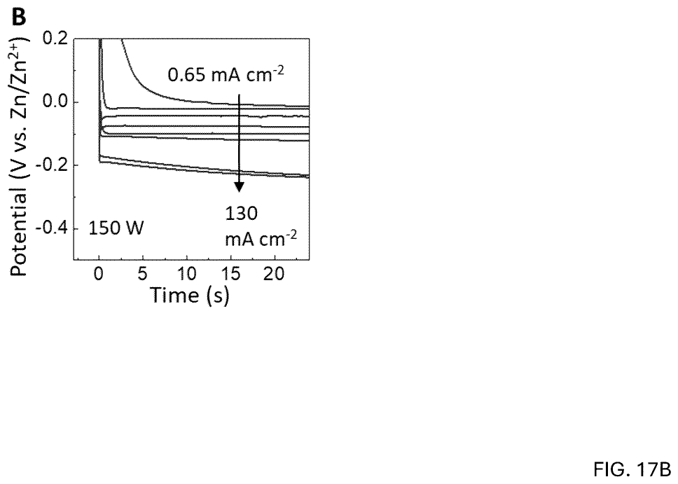

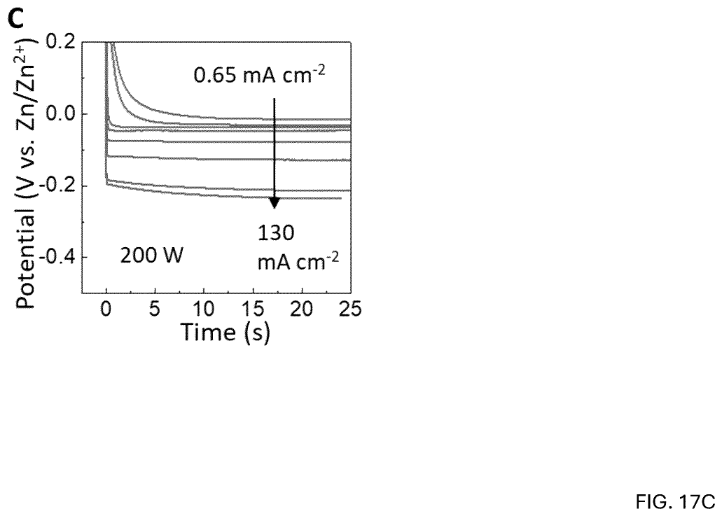

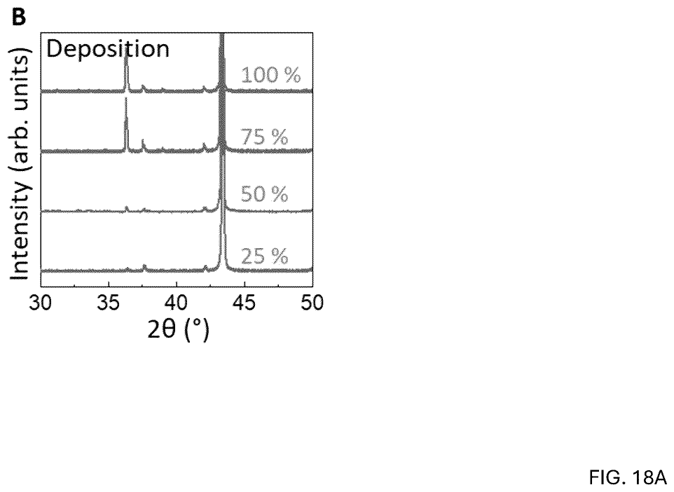

FIGS. 17A-17C show voltage profiles of zinc deposition on a bare (e.g., unmodified) copper foil current collector (FIG. 17A), a 150 W sputtered CuNPs-copper foil current collector (CuNPs diameter ˜50 nm) (FIG. 17B), a 200 W sputtered CuNPs-copper foil current collector (CuNPs diameter ˜200 nm) (FIG. 17C) at the following current densities: 0.65, 1.3, 6.5, 13, 26, 52, 104, 130 mA cm⁻².

### Example 11

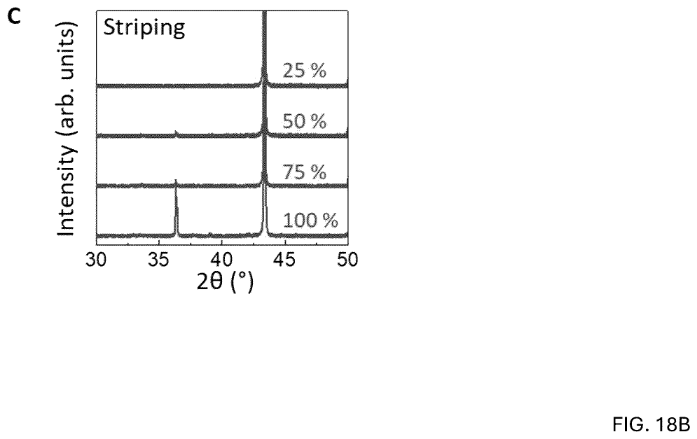

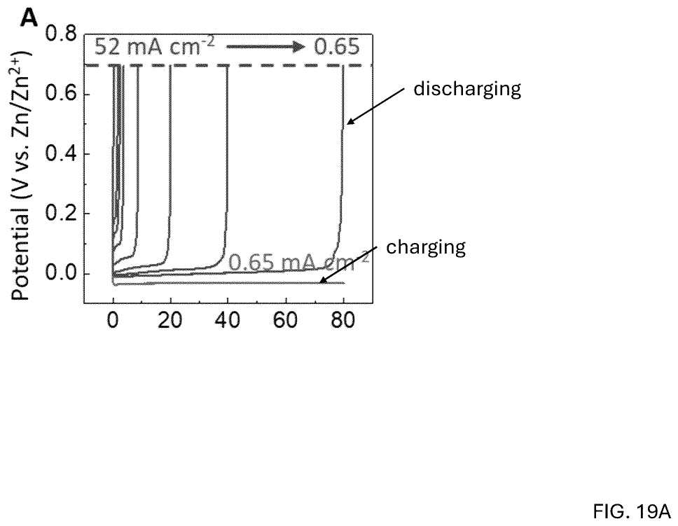

FIGS. 18A-18B show XRD results of zinc deposition at various state-of-charge increasing from 25% to 100% (FIG. 18A) and Zn stripping from 100% to 25% (FIG. 18B).

### Example 12

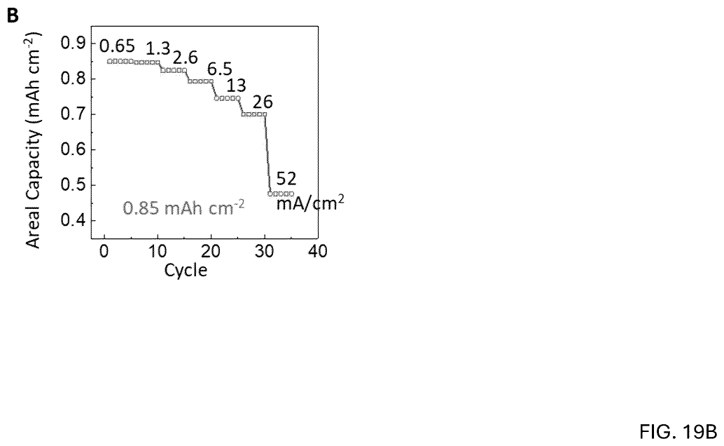

FIG. 19A show voltage profile of a charging and a discharging process of an example zinc anode at different current densities (0.65, 1.3, 2.6, 6.5, 13, 26, 52 mA cm⁻²). FIG. 19B shows the corresponding areal capacity changes with current density.

### Full Cell Characteristics

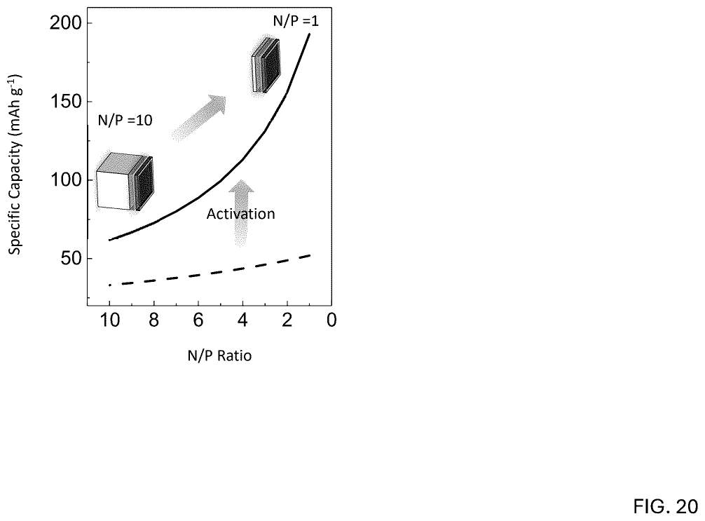

As described, electrochemical cells fabricated using the techniques described herein to include a porous AC cathode and a zinc anode with a nanoparticle-modified current collector can have a balanced or near-balanced electrode capacity ratio (n/p). FIG. 20 shows that cells with a balanced or near-balanced n/p ratio (e.g., a n/p ratio <10) can achieve increased cell capacity up to, e.g., three times greater than cells with an unbalanced n/p ratio (e.g., an n/p ratio >10).

### Example 13

In this example, supercapacitors were prepared, according to the provided fabrication techniques, at a n/p ratios of 4 and 2.5 (n: Zn; p: AC). The n/p ratio was calculated based on the areal capacities of the anode and the cathode measured by potential versus time characteristics.

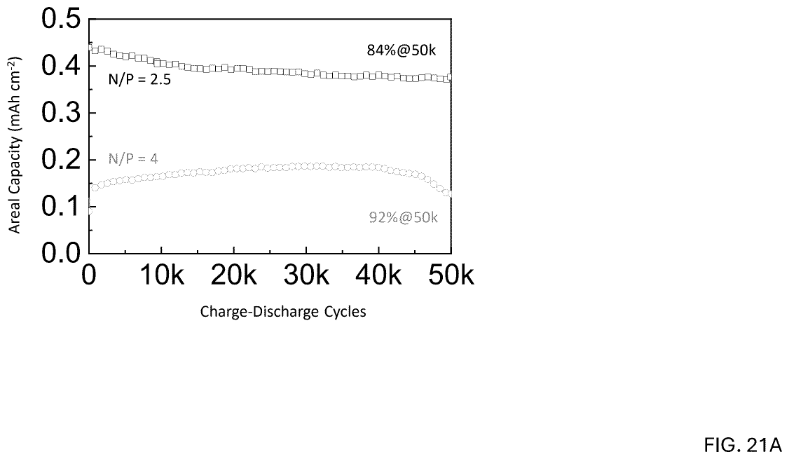

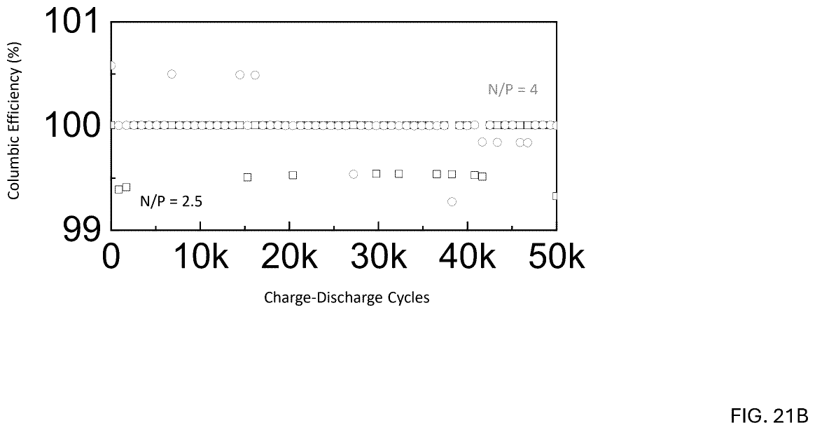

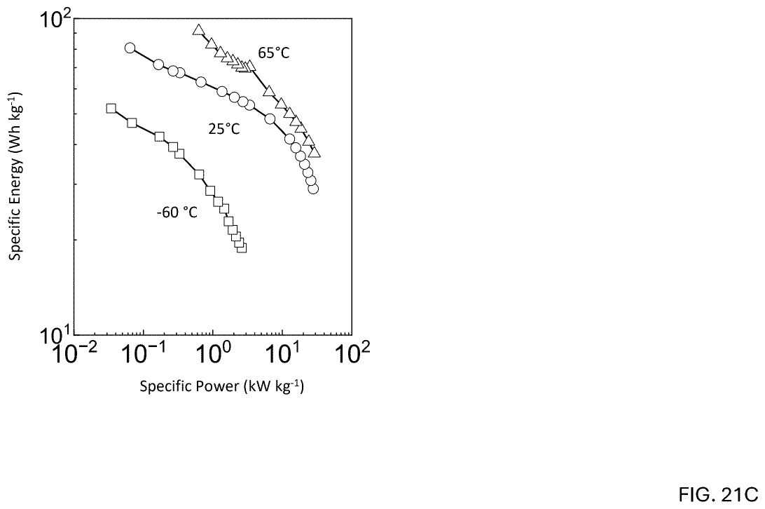

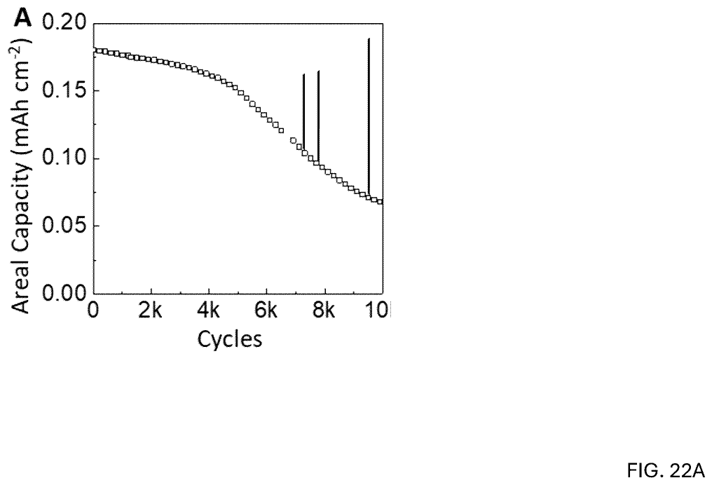

FIG. 21A shows that, as the n/p ratio was adjusted from 4 to 2.5, the areal capacity of the full cell increased by 2.87 times from 0.15 mAh cm 2 to 0.43 mAh cm⁻², while the equivalent gravimetric capacity was raised from 82.5 mAh g⁻¹ to 98.3 mAh g⁻¹.

As shown in FIG. 21B, following 50,000 full charge-discharge cycles (wherein each discharge was approximately 55 s at 26 mA cm⁻², from 2 V to 0 V), equivalent to 763 hours of discharge, the capacity retention was 92% for n/p=4 and 84% for n/p=2.5. Retention rates of >80% after 50,000 cycles demonstrated enhanced stability that can be attributed to the nanoparticle modification of the current collector to suppress zinc dendrites.

FIG. 21C shows a plot of energy versus power density for the n/p=2.5 supercapacitor (n/p=2.5), over a wide range of temperatures.

### Example 14

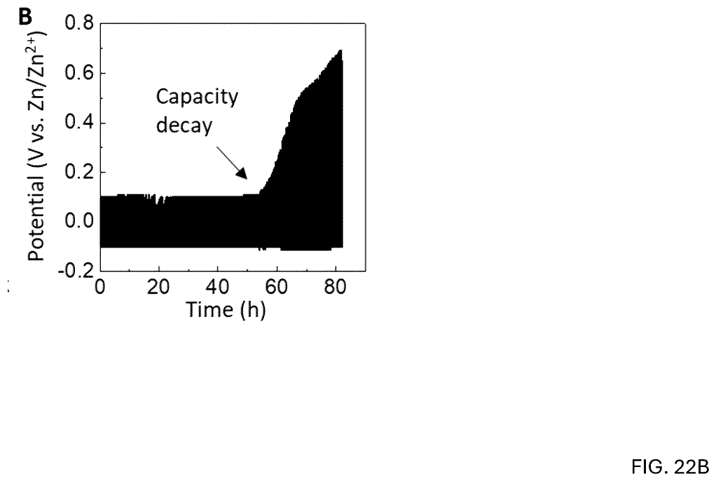

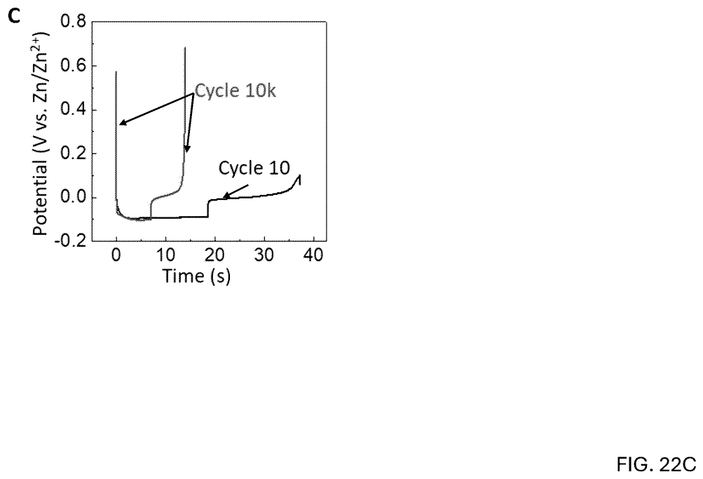

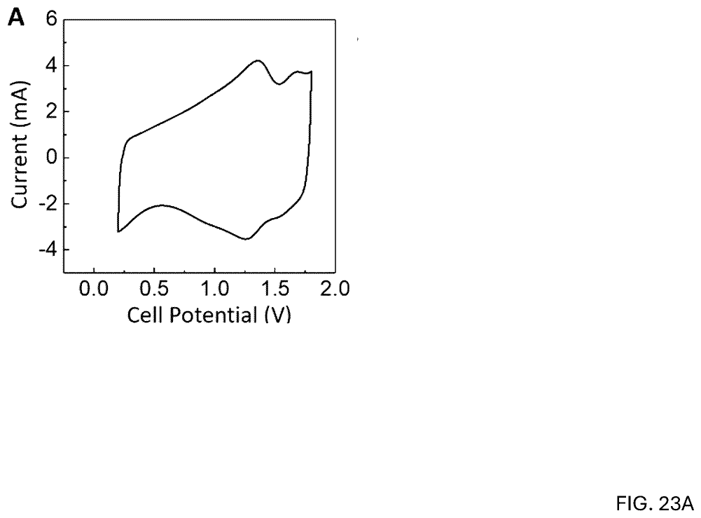

In this example, characteristics of an electrochemical cell having an AC cathode and an anode with a bare (e.g., unmodified) copper foil current collector were analyzed. The example cell had an n/p ratio of 4. Cycling performance data is plotted in FIG. 22A. FIG. 22B shows a plot of cell potential versus time at the anode side. FIG. 22C shows charging/discharging potential data of the anode at cycle 10 and cycle 10,000. This demonstrates that electrochemical cells with an unmodified current collector can drop up to or greater than 35% of their initial capacity after 10,000 cycles.

### Example 15

In this example, the stabilizing effect of the CuNPs was assessed in electrochemical cells using different electrolytes, including aqueous zinc sulfate and organic zinc bis(trifluoromethylsulfonyl)imide, in addition to water-in-salt ZnCl₂.

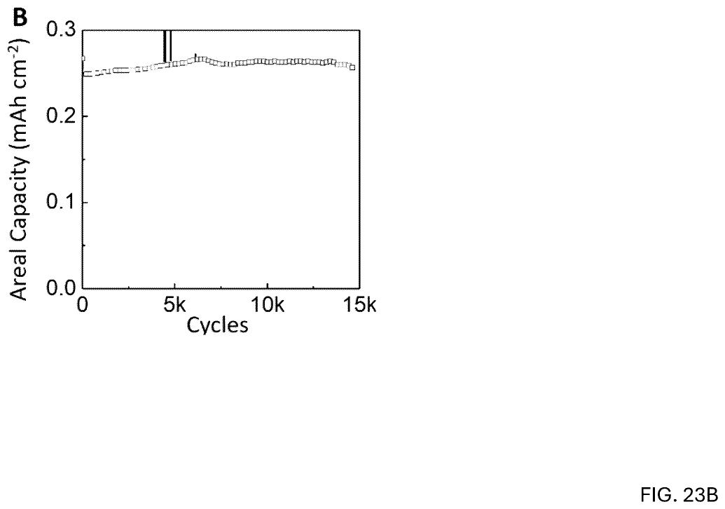

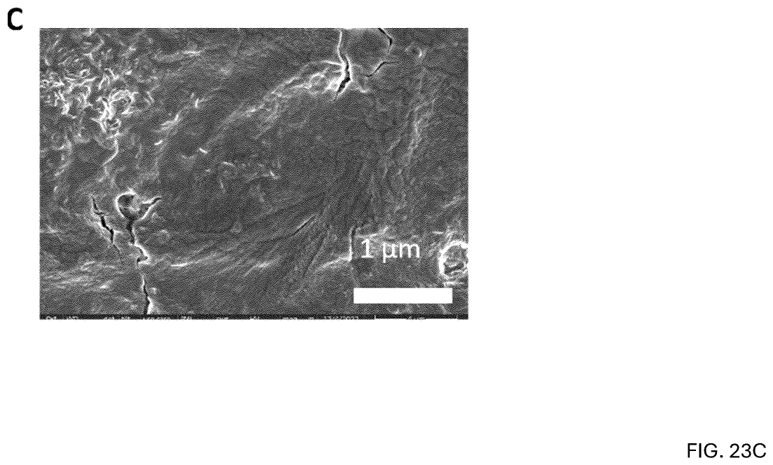

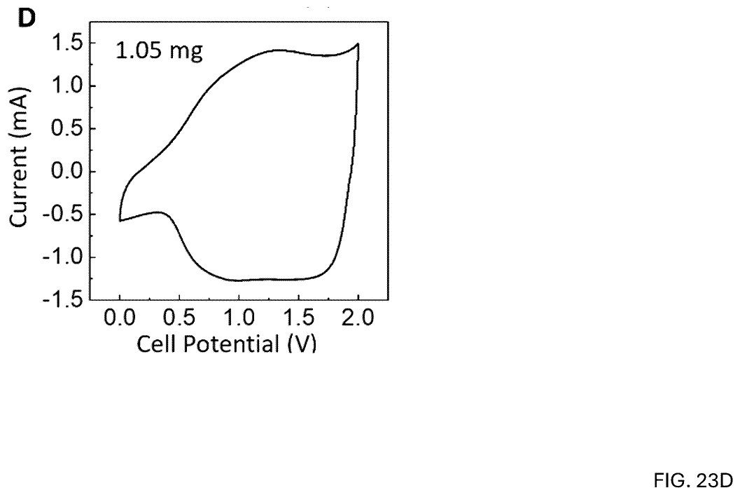

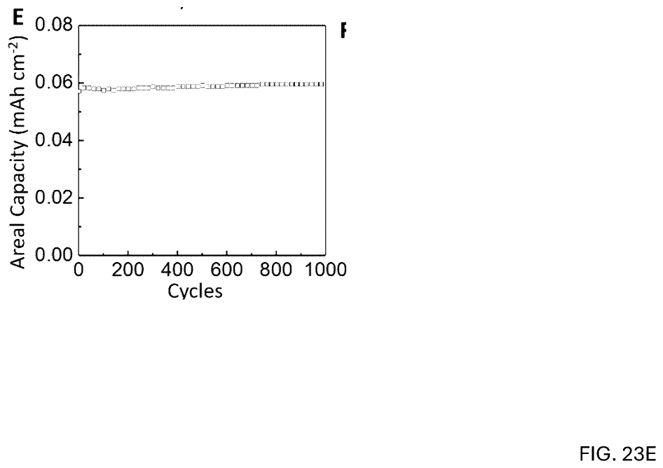

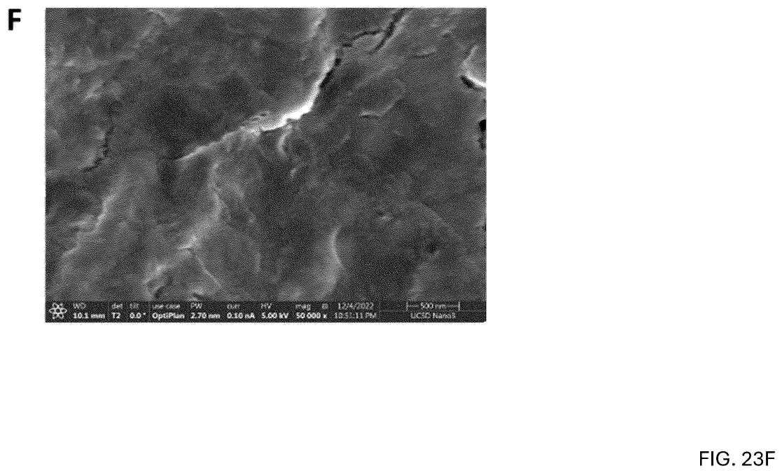

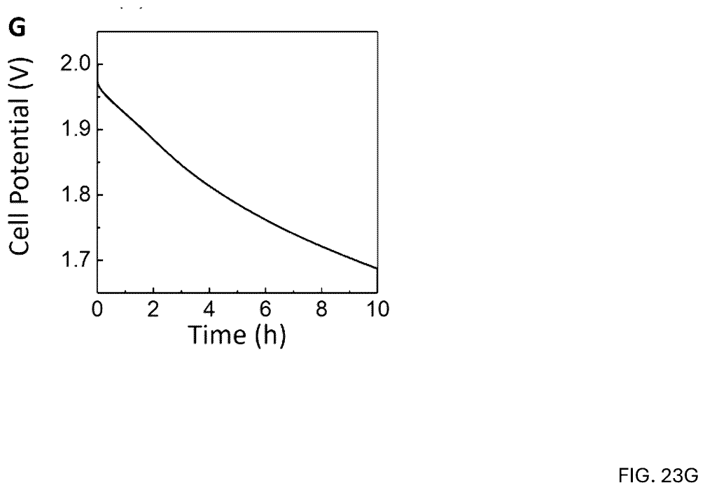

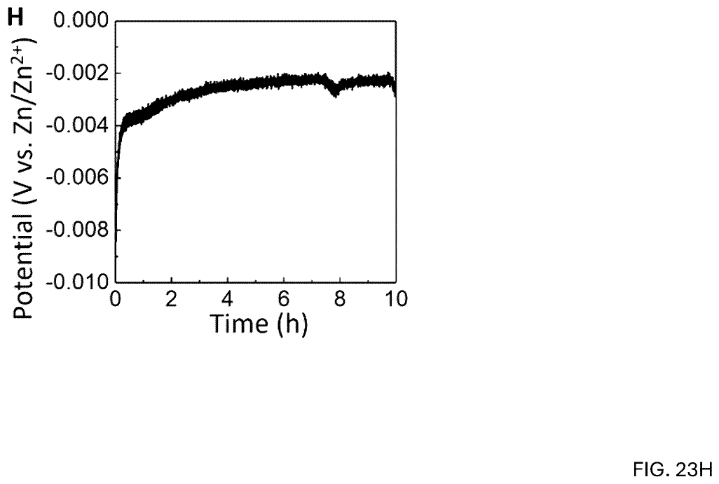

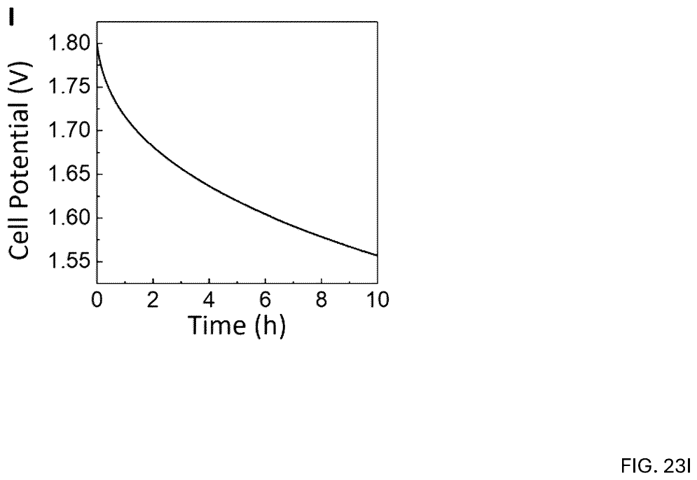

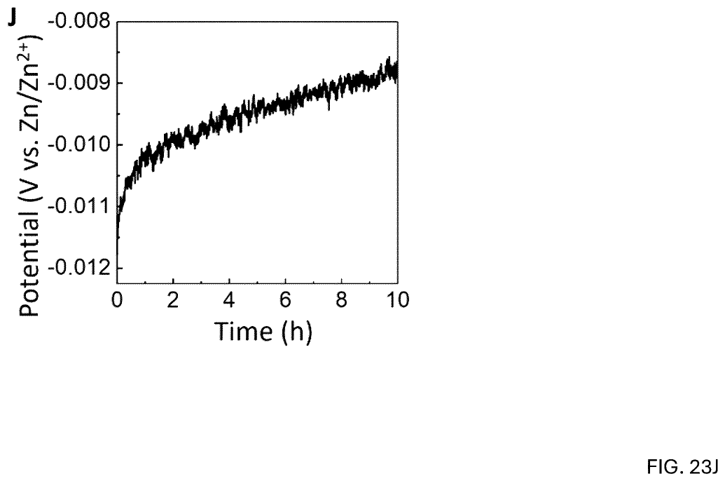

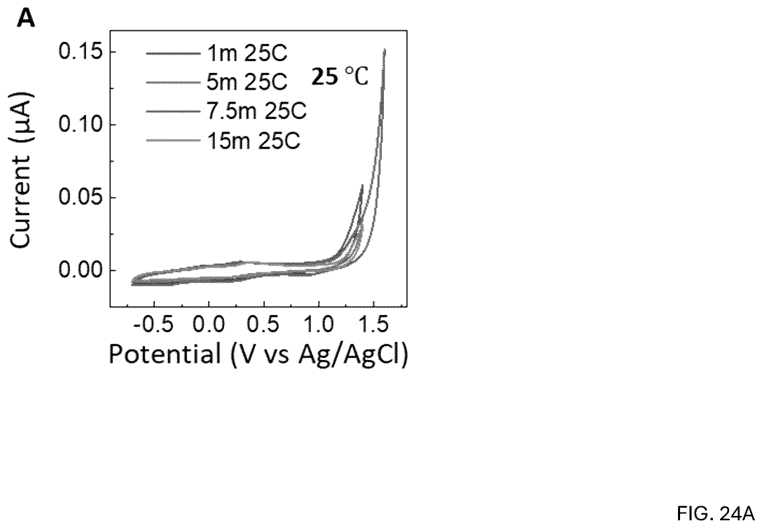

FIGS. 23A-23B show a cyclic voltammetry curve (FIG. 23A) and cycling performance data (FIG. 23B) for an electrochemical cell with n/p=4 and with 2 M ZnSO₄ in deionized water as the electrolyte. FIG. 23C shows an SEM image showing the surface morphology of the anode of the electrochemical cell of FIGS. 23A-23B after 1,000 full charging/discharging cycles.

FIGS. 23D-23E show a cyclic voltammetry curve (FIG. 23D) and cycling performance data (FIG. 23E) for an electrochemical cell with n/p=4 and 2 M Zinc bis(trifluoromethylsulfonyl)imide in propylene carbonate as the electrolyte. FIG. 23F shows an SEM image showing the surface morphology of the anode of this electrochemical cell after 1,000 full charging/discharging cycles.

FIG. 23G shows voltage drop data for an electrochemical cell with a 15 M ZnCl₂ electrolyte. FIG. 23H shows a plot of the potential change of zinc on a CuNPs-copper current collector anode during the self-discharge process.

FIG. 23I shows self-discharge performance data for an electrochemical cell with a 2 M ZnSO₄ electrolyte. FIG. 23J shows a plot of the potential change of zinc on CuNPs-Cu anode during the self-discharge process.

### Example 16

Electrochemical cells fabricated using the provided techniques can operate across a wide temperature range of −60° C. and 65° C., based on the use of water-in-salt (WIS) electrolyte. A high concentration of ZnCl₂ in the WIS electrolyte minimizes hydrogen bonding, allowing the electrolyte to remain in a liquid state and maintain sufficient ionic conductivity at low temperatures.

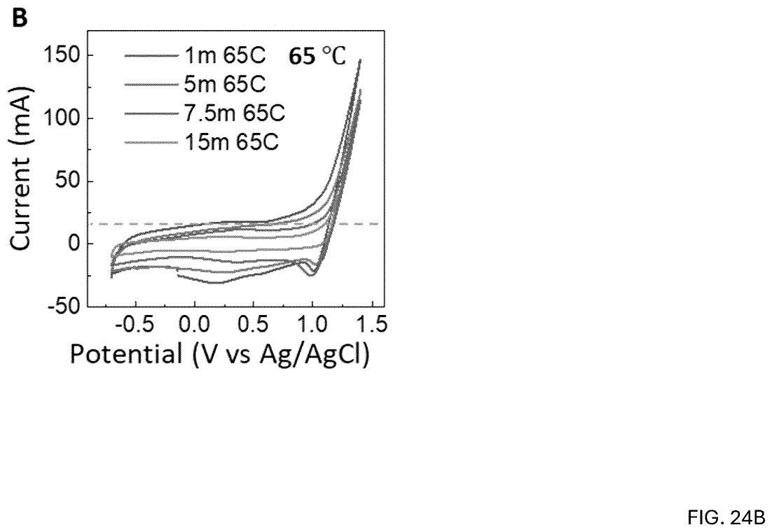

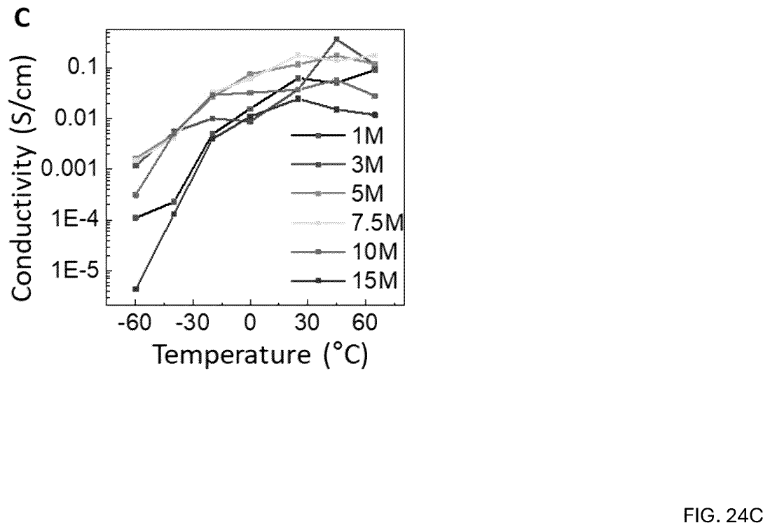

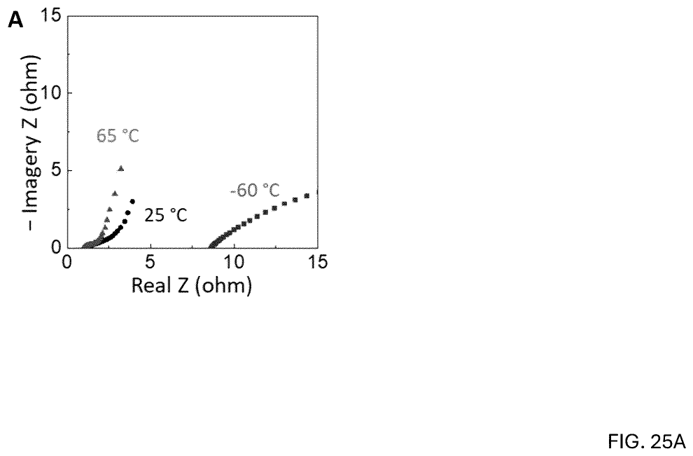

FIGS. 24A-24C show plots of the potential window (FIGS. 24A-24B) and conductivity (FIG. 24C) of water in salt electrolyte (WIS) at different ZnCl₂ concentrations and temperatures. As shown, the ionic conductivity reached a peak at 7.5 M, achieving 0.1 Scm⁻¹, but then declined with higher concentrations due to increasing viscosity with high salt content. The 7.5 M WIS electrolyte afforded a 2 V potential window and enabled the supercapacitor to operate under an extreme temperature of −60° C. with a low 8.5Ω internal resistance.

### Example 17

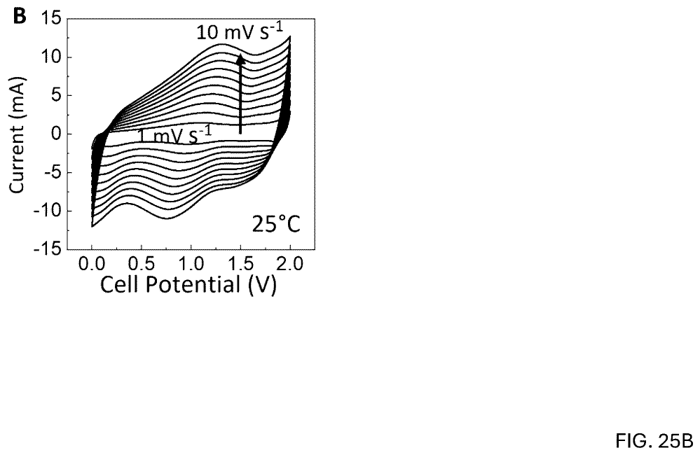

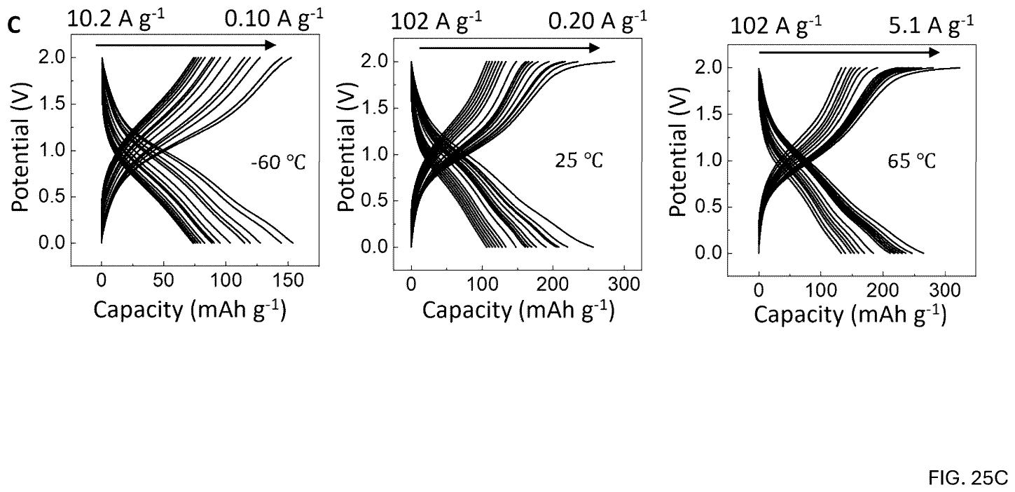

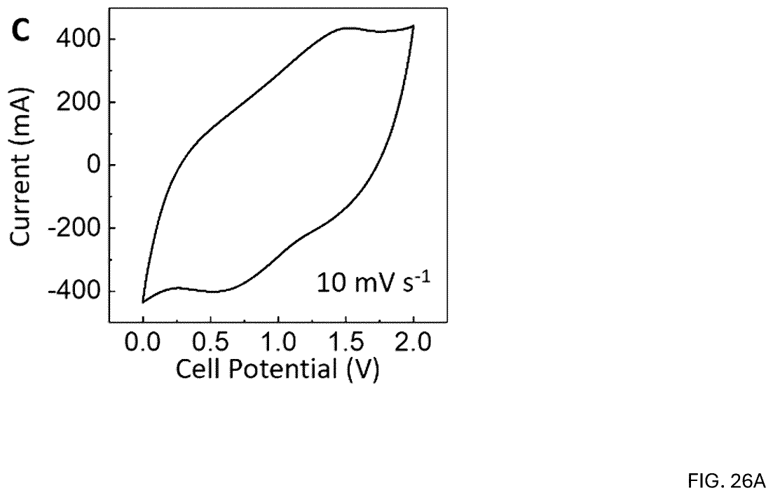

FIGS. 25A-25C show example data illustrating various characteristics of an example supercapacitor fabricated according to the disclosed techniques. FIG. 25A shows a plot of the impedance of the supercapacitor held at 1 V at −60° C., 25° C., and 65° C. FIG. 25B shows cyclic voltammetry curves with scan rates of 1 mV/s to 10 mV/s for the example supercapacitor. FIG. 25C shows voltage-capacity profiles of the supercapacitor at various charge/discharge currents and at different temperatures. This data demonstrates that supercapacitor performance can be enhanced with rising temperature. Moreover, this data indicates that the supercapacitors have a wide temperature tolerance since, at 65° C., the specific energy rose to 208 Wh kg⁻¹ at 1.43 kW kg⁻¹.

### Example 18

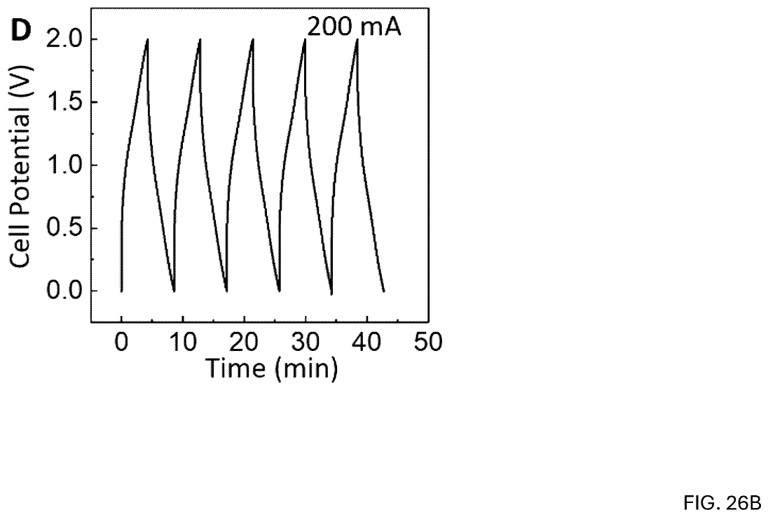

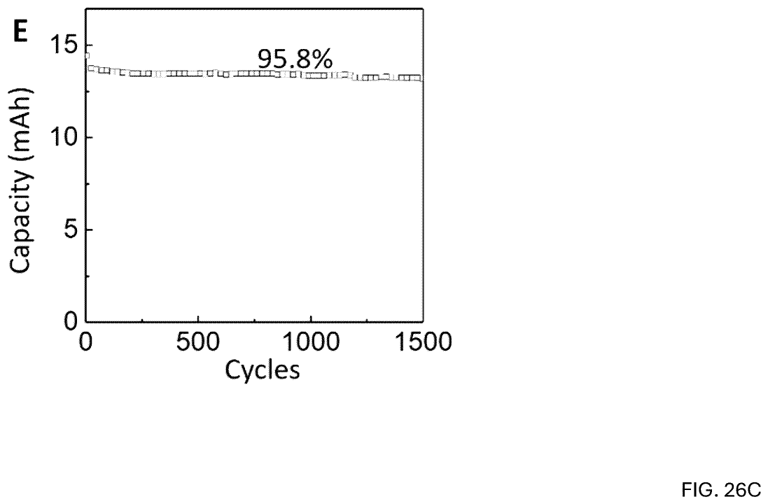

FIGS. 26A-26C show example data illustrating characteristics of the 4 cm×5.5 cm electrochemical cell shown in FIG. 3. This example cell has an n/p ratio of 2.5, a capacitance of 25.8 F, and a capacity of 14.4 mAh. FIG. 26A shows a cyclic voltammetry curve of the example cell. FIG. 26B shows charge-discharge characteristics of the cell at a current of 200 mA. FIG. 26C illustrates the cycling stability of the cell over 1500 charge-discharge cycles of 2 V. Notably, after 1,000 charge-discharge cycles, the device retained 95.8% of its initial capacity, indicating high cycling stability and uniform zinc plating/striping over a substantial area.

### Example 19

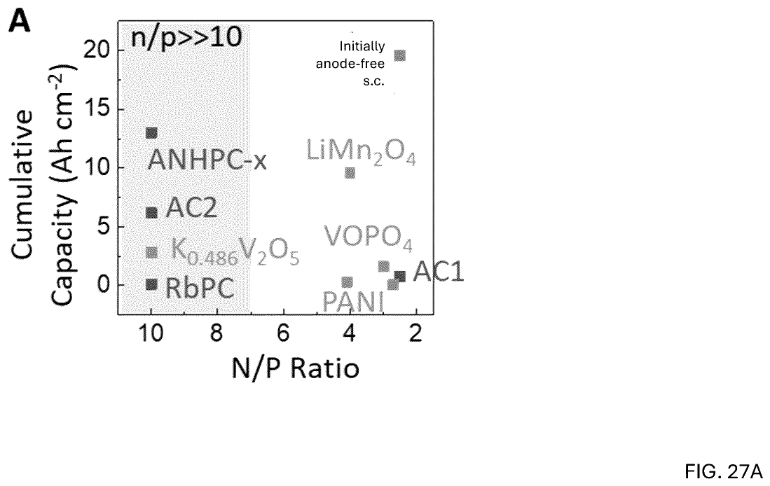

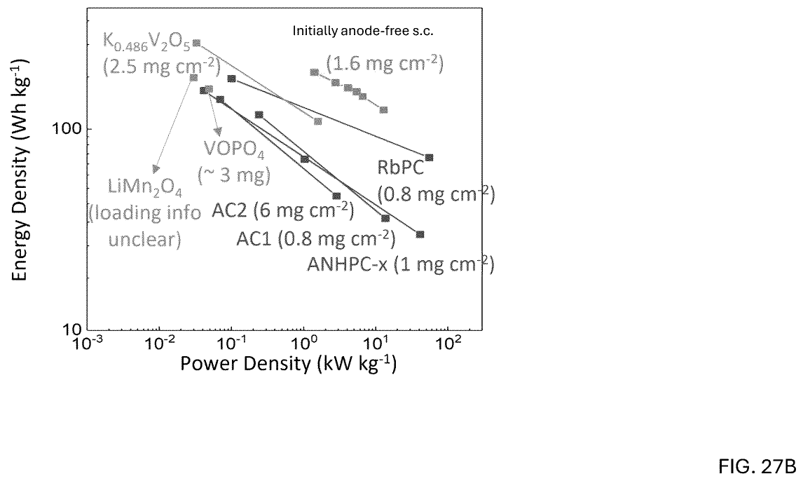

FIGS. 27A-27B show data comparing characteristics of the provided electrochemical cells. Specifically, FIGS. 27A-27B shows cumulative capacity data (FIG. 27A) and specific energy and specific power data (FIG. 27B) of an example supercapacitor fabricated according to the provided techniques (labeled “initially anode-free s.c.” in FIGS. 27A-27B) compared to example existing zinc ion batteries (LiMn₂O₄, PANI, K_{0.486} V₂O₅, VOPO₄) and example existing zinc ion capacitors (AC1 (n/p=2.5), AC2 (n/p>10), ANHPC-x, RbPC). The supercapacitor in this example had a n/p ratio of 2.5, 1.6 mg cm⁻² active carbon on carbon cloth as cathode, a copper current collector with CuNPs sputtered at 100 W as anode current collector, a 1.26 mg cm⁻² active Zn amount, and 200 μL 15 M ZnCl₂ as electrolyte.

### Example 20

Table 1 below shows data comparing an example electrochemical cell fabricated using the provided techniques (row 2) to various existing zinc ion supercapacitors and batteries (rows 3-10).

TABLE 1

| | | | | Gravimetric | | | Areal | Cumulative | | |
|---|---|---|---|---|---|---|---|---|---|---|
| | | | | capacity | Specific | Specific | Capacity | capacity | | |
| | | | Potential | (mAh | Power | Energy | (mAh | (Ah | | N/P |
| Cathode | Anode | Electrolyte | (V) | g⁻¹) | (W/kg) | (Wh/kg) | cm⁻²) | cm⁻²) | Stability | ratio |
| AC | Cu—Zn | 15M | 0-2 | 246 | 190-1400 | 210-139.7 | 0.4 | 19.8 | 83% | 2.5 |
| 1.26 mg | | ZnCl₂ | | | | | | | 50k | |
| AC | NPC | 2M | 0.2-1.8 | 70 | 1031 | 71 | 1 | 0.8 | 98% | 2.5 |
| 1 mg | Ns/ | ZnSO₄ | | @5 mA | | | | | 2k | |
| | Cu | | | cm⁻² | | | | | cycles | |
| AC | Zn@ | 2M | 0.2-1.8 | 132 | 70.0 | 140.8 | 0.48 | 6.19 | 72% | 21 |
| 6 mg | MOF | ZnSO₄ | | @0.1 A/g | | | | | 20k | |
| cm⁻² | | | | | | | | | cycles | |
| AC | Zn | [Zn | 0-2.5 | 80 | 240 | 118 cathode | 0.064 | 0.64 | 90% | >10 |
| 0.4-0.8 | (25 × | (bet)₂][NTf₂]₂ | | @0.5 A/g | | | | | 10k | |
| mg/cm⁻² | 10 × | (ZbN) | | | | | | | cycles | |
| | 0.25 mm) | (AN) | | | | | | | | |
| ANHPC- | Zn | | | 199.1 | 41.4 | 155.2 | 0.2 | 13 | 99% | >10 |
| x, 1 mg | foil | | | @0.5 A/g | | | | | 65k | |
| cm⁻² | | | | | | | | | cycles | |
| RbPC | Zn | 1M | 0.2-1.8 | 216 | 100 | 178.2 | 0.064 | 0.12 | 99.8% | >10 |
| 0.8 mg | foil | Zn | | | | | | | 20k | |
| | | (CF₃SO₃)₂ | | | | | | | cycles | |
| MnO₂ | Cur-C | / | 0.8-1.8 | 200 | / | 135 Wh/kg | 0.5 | 0.04 | / | >10 |
| PANI | 10 um | / | / | 220 | 900 | 175 | 1.8 | 0.09 | 68% | |
| | Zn | | | @0.05 A/g | | | | | 80 | |
| | | | | | | | | | cycles | |
| PANI | 20 um | / | / | 77 | 10000 | 110 | 1.9 @0.2 A/g | 0.285 | 100% | 2.7 |
| | Zn | | | @10 A/g | | | | | 50 | |
| | | | | | | | | | cycles | |
| LiMn₂O₄ | Zn | 20M | ~1.7 | 66 | 30 | 180 | 2.4 @0.2 C | 9.6 | 100% | 2.7 |
| | | LiITFSI + | | | | | | | 150 | |
| | | 1M | | | | | | | cycles | |
| | | Zn(TFSI)₂ | | | | | | | | |
| K_{0.486}V₂O₅ | Zn | SCCa | 1.6 | 400 | 32.85 | 268.2 | 1 | 2.8 | 4k | 4.1 |
| @2.5 | | 15M | | | (1800) | (110) | | | cycles | |
| mg/cm² | | ZnCl₂ | | | | | | | | |
| VOPO | Zn—Ti | 4M Zn | | 163 | 0.049 | 158.6 | ~0.3 | 1.62 | 89% | 3 |
| | | (OTF)₂ + | | | | | | | 6k | |
| | | 0.5M | | | | | | | | |
| | | Me₃Et | | | | | | | | |
| | | NOTF | | | | | | | | |

One skilled in the art will appreciate further features and advantages of the devices, systems, and methods based on the above-described embodiments. Accordingly, this disclosure is not to be limited by what has been particularly shown and described, except as indicated by the appended claims. All publications and references cited herein are expressly incorporated herein by reference in their entirety for all purposes.

The present disclosure has been described above by way of example only within the context of the overall disclosure provided herein. It will be appreciated that modifications within the spirit and scope of the claims may be made without departing from the overall scope of the present disclosure.

1. An electrochemical cell comprising:
an anode; and
a cathode;
wherein:
prior to application of a reduction voltage to the anode, the cathode comprises activated carbon and a zinc deposit, and the anode comprises no zinc deposit; and
following application of the reduction voltage to the anode, the anode comprises the zinc deposit, and the cathode comprises no zinc deposit.

2. The electrochemical cell of claim 1, wherein the anode comprises a current collector comprising a nanoparticle-modified surface.

3. The electrochemical cell of claim 2, wherein the nanoparticle-modified surface comprises copper nanoparticles.

4. The electrochemical cell of claim 2, wherein the nanoparticle-modified surface is fabricated using a radio frequency sputtering process.

5. The electrochemical cell of claim 2, wherein, following the application of the voltage to the anode, the zinc deposit is layered over the nanoparticle-modified surface.

6. The electrochemical cell of claim 2, wherein, following the application of the voltage to the anode, a thickness of the zinc deposit on the anode is less than 10 μm.

7. The electrochemical cell of claim 1, wherein a capacity ratio (n/p) of the electrochemical cell is less than 5.

8. An electrochemical cell comprising:
an anode; and
a cathode, the cathode comprising:
a substrate; and
a layer of activated carbon disposed on a surface of the substrate, the layer of active carbon comprising pores.

9. The electrochemical cell of claim 8, wherein the pores are formed by decomposing an electrolyte with chloride anions using the cathode.

10. The electrochemical cell of claim 9, wherein the electrolyte comprises zinc chloride.

11. The electrochemical cell of claim 8, wherein the substrate comprises carbon cloth.

12. The electrochemical cell of claim 8, wherein a capacitance of the cathode is at least 200 Farad per gram.

13. A method comprising:
assembling a first electrochemical cell comprising a cathode comprising a layer of activated carbon, a first anode, and a first electrolyte comprising chloride ions;
applying a first voltage across the cathode and the first anode to decompose the first electrolyte;
depositing a layer of zinc over the layer of activated carbon;
assembling a second electrochemical cell comprising the cathode, an anode current collector for a second anode, and a second electrolyte; and
applying a reduction voltage across the cathode and the anode current collector for the second anode to strip the layer of zinc from the cathode and deposit the layer of zinc on a surface of the anode current collector to form the second anode.

14. The method of claim 13, wherein the first electrolyte comprises zinc chloride.

15. The method of claim 13, wherein the first voltage applied to the cathode and the first anode to decompose the first electrolyte is greater than 2.1 V.

16. The method of claim 13, further comprising, prior to assembling the second electrochemical cell:
modifying a surface of the anode current collector with nanoparticles to form a nanoparticle-modified surface.

17. The method of claim 16, wherein modifying the surface of the anode current collector comprises depositing the nanoparticles by radio frequency sputtering.

18. The method of claim 17, wherein the nanoparticles comprise copper nanoparticles.

19. The method of claim 13, wherein a thickness of the layer of zinc is less than less than 5 μm.

20. The method of claim 13, wherein, following decomposition of the first electrolyte, the layer of activated carbon comprises a plurality of pores.
